(19) United States
(12) Patent Application Publication
(10) Pub. No.: US 2026/0292263 A1
(43) Pub. Date: Sep. 24, 2026

(54) IMAGE DECODING METHOD, IMAGE DECODING DEVICE, IMAGE ENCODING METHOD, AND IMAGE ENCODING DEVICE FOR PERFORMING IN-LOOP FILTERING BY USING NEURAL NETWORK

(71) Applicant: SAMSUNG ELECTRONICS CO., LTD., Suwon-si (KR)

(72) Inventors: Quockhanh DINH, Suwon-si (KR); Kwangpyo CHOI, Suwon-si (KR)

(73) Assignee: SAMSUNG ELECTRONICS CO., LTD., Suwon-si (KR)

(21) Appl. No.: 19/531,029

(22) Filed: Feb. 5, 2026

Related U.S. Application Data
(63) Continuation of application No. PCT/KR2024/008347, filed on Jun. 17, 2024.

(30) Foreign Application Priority Data
Aug. 18, 2023 (KR) 10-2023-0108571
May 8, 2024 (KR) 10-2024-0060764

(51) Int. Cl. H04N 19/82; H04N 19/117; H04N 19/136; H04N 19/172; H04N 19/42

(52) U.S. Cl. CPC H04N 19/82; H04N 19/117; H04N 19/136; H04N 19/172; H04N 19/42

(57) ABSTRACT

An image decoding method includes: generating, based on first state information obtained from a feature map corresponding to a first reference image for a current image or second state information obtained from a feature map corresponding to a second reference image for the current image, layer information to be used in at least one layer within a filtering neural network; inputting, to the at least one layer within the filtering neural network, information corresponding to the current image; and obtaining an image in which in-loop filtering has been applied to the current image by inputting, to the at least one layer in which the layer information has been used, the information corresponding to the current image, wherein state information for the current image is obtained from a feature map corresponding to the current image and the state information has a resolution lower than a resolution of the current image.

### CROSS-REFERENCE TO RELATED APPLICATIONS

This application is a continuation of International Application No. PCT/KR2024/008347, filed on Jun. 17, 2024, which is based on and claims priority to Korean Provisional Application No. 10-2023-0108571, filed on Aug. 18, 2023, and Korean Patent Application No. 10-2024-0060764, filed on May 8, 2024, in the Korean Intellectual Property Office, the disclosures of which are incorporated by reference herein in their entireties.

### BACKGROUND

### 1. Field

The present disclosure relates to the field of image encoding and decoding and relates to a method and device for encoding and decoding an image by performing in-loop filtering using a neural network on a current block included in a current image.

### 2. Description of Related Art

In codecs such as H.264 Advanced Video Coding (AVC) and High Efficiency Video Coding (HEVC), an image may be divided into blocks, and each of the blocks may be prediction-encoded and prediction-decoded through inter-prediction or intra-prediction.

Intra-prediction is a method of compressing an image by removing spatial redundancy within an image, and inter-prediction is a method of compressing an image by removing temporal redundancy between images.

As a representative example of inter-prediction, there is motion estimation encoding which predicts blocks of a current image by using a reference image. A reference block that is most similar to a current block may be searched for within a predefined search range by using a predefined evaluation function. A current block is predicted based on a reference block, and a residual block is generated and encoded by subtracting a prediction block generated as a prediction result from the current block.

To derive a motion vector indicating a reference block in a reference image, motion vectors of previously encoded blocks may be used as a motion vector predictor of a current block. A differential motion vector, which is the difference between the motion vector of the current block and the motion vector predictor of the current block, is signaled to the decoder side through a predefined method.

Recently, technologies for encoding/decoding images by using artificial intelligence (AI) have been proposed. Thus, methods of effectively encoding/decoding images by using AI, for example, neural networks, are required.

### SUMMARY

According to an aspect of the disclosure, an image decoding method includes: generating, based on first state information obtained from a feature map corresponding to a first reference image for a current image or second state information obtained from a feature map corresponding to a second reference image for the current image, layer information to be used in at least one layer within a filtering neural network; inputting, to the at least one layer within the filtering neural network, information corresponding to the current image; and obtaining an image in which in-loop filtering has been applied to the current image by inputting, to the at least one layer in which the layer information has been used, the information corresponding to the current image, wherein state information for the current image is obtained from a feature map corresponding to the current image and the state information for the current image has a resolution lower than a resolution of the current image.

According to an aspect of the disclosure, an image encoding method includes: generating, based on first state information obtained from a feature map corresponding to a first reference image for a current image or second state information obtained from a feature map corresponding to a second reference image for the current image, layer information to be used in at least one layer within a filtering neural network; inputting, to the at least one layer within the filtering neural network, information corresponding to the current image; and obtaining an image in which in-loop filtering has been applied to the current image by inputting, to the at least one layer in which the layer information has been used, the information corresponding to the current image, wherein state information for the current image is obtained from a feature map corresponding to the current image and the state information for the current image has a resolution lower than a resolution of the current image.

According to an aspect of the disclosure, a non-transitory computer-readable recording medium stores instructions that are executed by at least one processor to perform image decoding method including: generating, based on first state information obtained from a feature map corresponding to a first reference image for a current image or second state information obtained from a feature map corresponding to a second reference image for the current image, layer information to be used in at least one layer within a filtering neural network; inputting, to the at least one layer within the filtering neural network, information corresponding to the current image; and obtaining an image in which in-loop filtering has been applied to the current image by inputting, to the at least one layer in which the layer information has been used, the information corresponding to the current image, wherein state information for the current image is obtained from a feature map corresponding to the current image and the state information for the current image has a resolution lower than a resolution of the current image.

According to an aspect of the disclosure, a device for encoding or decoding an image, includes: memory storing at least one instruction; and at least one processor, wherein the at least one instruction, when executed by the at least one processor individually or collectively, causes the image decoding device to: generate, based on first state information obtained from a feature map corresponding to a first reference image for a current image or second state information obtained from a feature map corresponding to a second reference image for the current image, layer information to be used in at least one layer within a filtering neural network, input, to the at least one layer within the filtering neural network, information corresponding to the current image, and obtain an image in which in-loop filtering has been applied to the current image by inputting, to the at least one layer in which the layer information has been used, the information corresponding to the current image, wherein state information for the current image is obtained from a feature map corresponding to the current image and the state information for the current image has a resolution lower than a resolution of the current image.

According to one or more embodiments of the present disclosure, it is possible to reconstruct details and improve image quality through in-loop filtering using a neural network. In addition, according to one or more embodiments of the present disclosure, the difference between an original image and a decoded image may be reduced.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an image encoding and decoding system that performs in-loop filtering, according to an embodiment of the present disclosure;

FIG. 2 is a diagram illustrating blocks divided from an image according to a tree structure, according to an embodiment of the present disclosure;

FIG. 3 is a diagram for describing a group of pictures (GOP) structure according to an embodiment of the present disclosure;

FIG. 4 is a diagram for describing a relationship between a current block and a reference block, according to an embodiment of the present disclosure;

FIG. 5 is a diagram illustrating an in-loop filtering operation according to an embodiment of the present disclosure;

FIG. 6 illustrates a block diagram of an in-loop filtering unit according to an embodiment of the present disclosure;

FIG. 7 is a diagram for describing a process of outputting an intermediate image from a filtering neural network, according to an embodiment of the present disclosure;

FIGS. 8A, 8B, and 8C are diagrams for describing a filtering neural network using layer information, according to an embodiment of the present disclosure;

FIG. 9 is a diagram illustrating a structure of a feature extraction neural network included in a filtering neural network, according to an embodiment of the present disclosure;

FIG. 10 is a diagram illustrating a structure of a regression neural network included in a filtering neural network, according to an embodiment of the present disclosure;

FIGS. 11A, 11B, and 11C are diagrams illustrating a structure of a layer information neural network according to an embodiment of the present disclosure;

FIG. 12 is a diagram illustrating a method of training a filtering neural network, according to an embodiment of the present disclosure;

FIG. 13 is a block diagram illustrating a configuration of an image decoding device according to an embodiment of the present disclosure;

FIG. 14 is a flowchart of an image decoding method according to an embodiment of the present disclosure;

FIG. 15 is a block diagram illustrating a configuration of an image encoding device according to an embodiment of the present disclosure; and

FIG. 16 is a flowchart of an image encoding method according to an embodiment of the present disclosure.

### DETAILED DESCRIPTION

Throughout the present disclosure, the expression “at least one of a, b or c” indicates only a, only b, only c, both a and b, both a and c, both b and c, or all of a, b, and c.

It will be understood that the singular forms “a,” “an,” and “the” as used herein include the plural forms as well unless the context clearly indicates otherwise. Therefore, for example, the term “configuration surface” may also include a case that indicates one or more of such surfaces.

In describing the present disclosure, descriptions of technical contents that are well known in the technical field to which the present disclosure belongs and are not directly related to the present disclosure will be omitted. By omitting unnecessary descriptions, the present disclosure may be described more clearly without obscuring the gist of the present disclosure. Terms as used herein are those defined by taking into account the functions in the present disclosure, but the terms may vary depending on the intention of users or those of ordinary skill in the art, precedents, or the like. Therefore, the definitions should be made based on the contents throughout the present specification.

For the same reason, some elements in the accompanying drawings are exaggerated, omitted, or schematically illustrated. In addition, the size of each element does not entirely reflect the actual size. The same reference numerals are assigned to the same or corresponding elements in the drawings.

Advantages and features of the present disclosure, and methods of achieving them will be clarified with reference to embodiments described below in detail with reference to the accompanying drawings. However, the present disclosure is not limited to the following embodiments and may be embodied in different various forms. Embodiments presented below are provided so that the present disclosure will be thorough and complete and will fully convey the concept of the present disclosure to those of ordinary skill in the art. An embodiment of the present disclosure may be defined by the claims. The same reference numerals denote the same elements throughout the specification. Furthermore, in describing an embodiment of the present disclosure, when the detailed description of the relevant functions or configurations is determined to unnecessarily obscure the gist of the present disclosure, the detailed description thereof may be omitted herein. Terms as used herein are those defined by taking into account the functions in the present disclosure, but the terms may vary depending on the intention of users or those of ordinary skill in the art, precedents, or the like. Therefore, the definitions should be made based on the contents throughout the specification.

It will be understood that the blocks in the flowcharts and combinations of the flowcharts in the present disclosure may be performed by one or more computer programs including computer-executable instructions. The one or more computer programs may be stored in single memory, or may be segmented and stored in a plurality of different memories.

In an embodiment, it will be understood that the respective blocks of the flowcharts and combinations of the flowcharts may be performed by computer program instructions. Computer program instructions may be mounted on processors of general-purpose computers, special-purpose computers, or other programmable data processing apparatuses, and the instructions to be executed through the processors of the computers or other programmable data processing apparatuses may generate a means for performing the functions described in the flowchart block(s). Because computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing an instruction means for performing the functions described in the flowchart block(s). Computer program instructions may also be mounted on computers or other programmable data processing apparatuses.

In addition, each block in the flowcharts may represent part of a module, segment, or code that includes one or more executable instructions for executing a specified logical function(s). In an embodiment, the functions mentioned in blocks may occur out of order. For example, two blocks illustrated in succession may in fact be executed substantially concurrently, or the blocks may sometimes be executed in a reverse order, depending on the functions involved therein.

All functions or operations described in the present disclosure may be processed by a single processor or a combination of processors. The single processor or the combination of processors is circuitry that performs processing and may include circuitry, such as an application processor (AP), a communication processor (CP), a graphics processing unit (GPU), a neural processing unit (NPU), a microprocessor unit (MPU), a system on chip (SoC), or an integrated chip (IC).

The term ‘unit’ as used in an embodiment of the present disclosure refers to a software element or a hardware element, such as a field programmable gate array (FPGA) or an application specific integrated circuit (ASIC), and the ‘unit’ may perform specific functions. However, the term ‘unit’ is not limited to software or hardware. The term ‘unit’ may be configured in an addressable storage medium or may be configured to reproduce one or more processors. In an embodiment, the term ‘unit’ may include elements, such as software elements, object-oriented software elements, class elements, and task elements, processes, functions, attributes, procedures, subroutines, segments of program code, drivers, firmware, microcodes, circuits, data, databases, data structures, tables, arrays, and variables. Functions provided through specific elements or specific ‘units’ may be combined to reduce the number thereof or may be separated into additional elements. In addition, in an embodiment, the ‘unit’ may include one or more processors.

In the present disclosure, an ‘image’ may represent a still image, a picture, a frame a moving image composed of a plurality of consecutive still images, or a video.

In the present disclosure, a ‘neural network’ is a representative example of an artificial neural network model that simulates brain nerves, and is not limited to an artificial neural network model using a specific algorithm. The neural network may be referred to as at least one of a deep neural network, a convolution neural network, and a transformer neural network.

In the present disclosure, a ‘current image’ refers to an image to be currently processed, and a ‘previous image’ refers to an image that is processed before the current image.

In the present disclosure, a ‘sample’ refers to data to be processed as data assigned to a sampling location within an image, a feature map, or feature data. For example, the sample may include a pixel within a two-dimensional image.

In the present disclosure, ‘state information’ may be information that comprehensively represents abstract features of an image, such as a main object included in a certain image, a shape of an object, a direction of a line, and a color distribution.

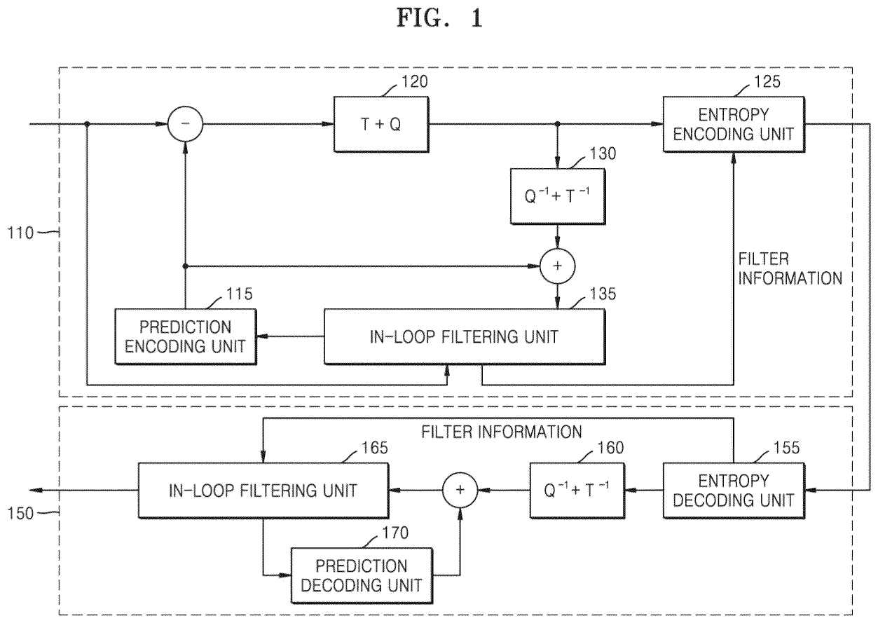

FIG. 1 illustrates a block diagram of an image encoding and decoding system that performs in-loop filtering, according to an embodiment of the present disclosure.

In an embodiment, an image encoding device 110 transmits, to an image decoding device 150, a bitstream generated through image encoding, and the image decoding device 150 reconstructs an image by receiving and decoding the bitstream.

In an embodiment, in the image encoding device 110, a prediction encoding unit 115 outputs a prediction block through inter-prediction and intra-prediction, and a transformation and quantization unit 120 outputs quantized transformation coefficients by transforming and quantizing residual samples of a residual block between the prediction block and a current block. An entropy encoding unit 125 outputs a bitstream by encoding the quantized transformation coefficients.

In an embodiment, the quantized transformation coefficients are reconstructed to the residual block including the residual samples in a spatial domain through an inverse quantization and inverse transformation unit 130. A reconstructed block, which is a combination of the prediction block and the residual block, is output as a filtered block through an in-loop filtering unit 135. A reconstructed image including the filtered block may be used as a reference image of a next input image in the prediction encoding unit 115.

In an embodiment, the bitstream received by the image decoding device 150 is reconstructed to the residual block including the residual samples in the spatial domain through an entropy decoding unit 155 and an inverse quantization and inverse transformation unit 160. The residual block and the prediction block output from a prediction decoding unit 170 are combined to generate a reconstructed block, and the reconstructed block is output as a filtered block through an in-loop filtering unit 165. A reconstructed image including the filtered block may be used as a reference image for a next image in the prediction decoding unit 170.

In an embodiment, the in-loop filtering unit 135 of the image encoding device 110 performs loop filtering by using filter information input according to a user input or system settings. The filter information used by the in-loop filtering unit 135 is transmitted to the image decoding device 150 through the entropy encoding unit 125. The in-loop filtering unit 165 of the image decoding device 150 may perform in-loop filtering, based on the filter information input from the entropy decoding unit 155.

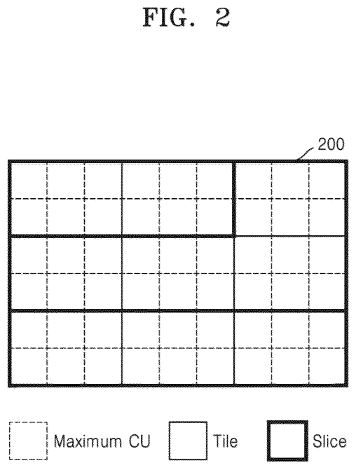

In an embodiment, in the image encoding and decoding process, the image is hierarchically divided, and the encoding and decoding are performed on blocks divided from the image. The blocks divided from the image are described with reference to FIG. 2.

FIG. 2 is a diagram illustrating blocks divided from an image according to a tree structure.

In an embodiment, one image 200 may be divided into one or more slices or one or more tiles. One slice may include a plurality of tiles. On the other hand, in the present specification, a video may have the same meaning as an image or a picture.

In an embodiment, one slice or one tile may be a sequence of one or more maximum coding units (CUs).

In an embodiment, one maximum CU may be divided into one or more CUs. The CU may be a reference block for determining a prediction mode. In other words, it may be determined whether an intra-prediction mode is applied to each CU or whether an inter-prediction mode is applied to each CU. In the present disclosure, the maximum CU may be referred to as a maximum coding block, and the CU may be referred to as a coding block.

In an embodiment, the size of the CU may be equal to the maximum CU or less than the maximum CU. Because the maximum CU is a CU with a maximum size, the maximum CU may also be referred to as the CU.

In an embodiment, one or more prediction units for intra-prediction or inter-prediction may be determined from the CU. The size of the prediction unit may be equal to the CU or less than the CU.

In an embodiment, one or more transform units for transformation and quantization may be determined from the CU. The size of the transform unit may be equal to the CU or less than the CU. The transform unit is a reference block for transformation and quantization, and residual samples of the CU may be transformed and quantized for each transform unit within the CU.

In an embodiment, the current block of the present disclosure may be a slice, a tile, a maximum CU, a CU, a prediction unit, or a transform unit divided from the image 200. In addition, a sub-block of the current block may be a block divided from the current block. For example, when the current block is the maximum CU, the sub-block may be the CU, the prediction unit, or the transform unit. In addition, an upper block of the current block is a block that includes the current block as a part. For example, when the current block is the maximum CU, the upper block may be a picture sequence, a picture, a slice, or a tile.

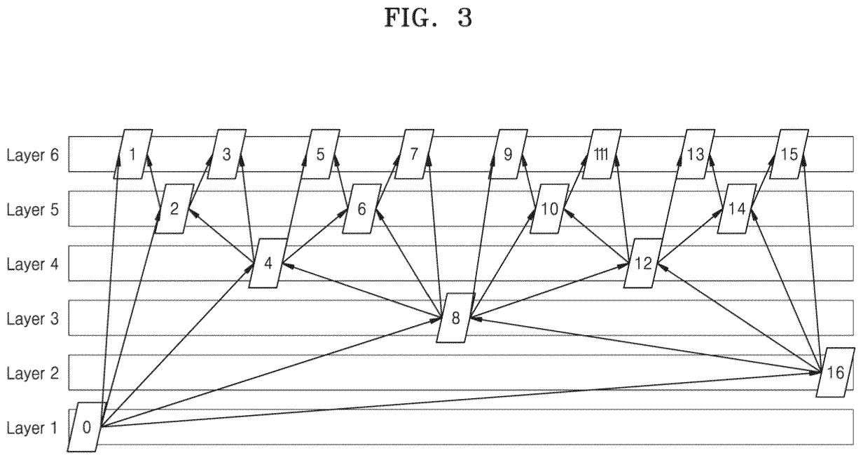

FIG. 3 is a diagram for describing a group of pictures (GOP) structure according to an embodiment of the present disclosure.

Referring to FIG. 3, a plurality of images may be compressed with reference to other images within the same group.

In an embodiment, the order of compression may be determined differently from the order of actual images, and thus, images that are temporally earlier or later may be used as reference images. For example, the order of actual images may be 0, 1, 2, . . . , 16, but the compression may be performed in the order of 0, 16, 8, . . . , 15. For the zeroth image, only the intra-prediction method is used because there is no image to be referenced, and for the subsequent images, the inter-prediction method is additionally used. In this case, the structure of 16 images from the first image to the sixteenth image is referred to as a GOP, and the GOP structure is used repeatedly. At t his time, the size of the GOP is 16. A plurality of images included in the GOP may be distinguished into a plurality of layers, based on the order of compression or the reference relationship. For example, the eighth, twelfth, and fourteenth images, which reference the sixteenth image, may be determined to be a higher layer than the sixteenth image.

In an embodiment, to increase the efficiency of compression when compressing an image, different values of quantization parameter (QP) may be used for each image. For example, the referenced image may lower the QP to improve the image quality and thus increase the efficiency of reference, and the referencing image may increase the QP to have a lower bitrate. Images in lower layers may use lower QPs because the images in lower layers are referenced more often, and images in higher layers may use relatively higher QPs. Images in the highest layer are not referenced in other image compression and therefore may use the highest QP. In such an embodiment, the referencing image may increase the efficiency of image compression by bringing out good image quality of the referenced image.

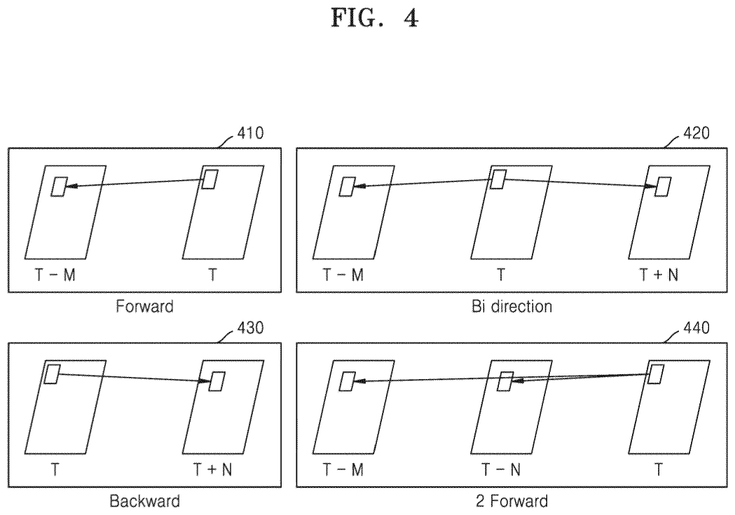

FIG. 4 is a diagram for describing the relationship between the current block and the reference block, according to an embodiment of the present disclosure.

Referring to FIG. 4, the relationship between the current block and the reference block may be a forward reference, a bi-direction reference, a backward reference, or a 2 forward reference.

In an embodiment, the relationship between the current block and the reference block may be a forward reference 410. When the time order of the current image is T, the time order of the reference image may be T−M, which is earlier than the current image.

In an embodiment, the relationship between the current block and the reference block may be a bi-direction reference 420. When the time order of the current image is T, the time order of the reference images may be T−M, which is earlier than the current image, and T+N, which is later than the current image.

In an embodiment, the relationship between the current block and the reference block may be a backward reference 430. When the time order of the current image is T, the time order of the reference image may be T+N, which is later than the current image.

In an embodiment, the relationship between the current block and the reference block may be a 2 forward reference 440. When the time order of the current image is T, the time order of the reference image may be T−M and T−N, which are earlier than the current image.

In an embodiment, the relationship between the current block and the reference block may be a 2 backward reference. When the time order of the current image is T, the time order of the reference image may be T+M and T+N, which are later than the current image.

In an embodiment, the image encoding device may determine an image to be used as the reference image for the current image in the image decoding device, and may determine motion information about sub-blocks included in the current image.

In an embodiment, the image decoding device may determine motion information, based on the relationship between the current image and the reference image. For example, motion information in which the current image and the reference image satisfy a predefined condition may be obtained from among pieces of motion information about a plurality of sub-blocks of the current block.

In an embodiment, the reference image may be determined from among images that are lower layers than the current image in the GOP.

In an embodiment, the reference image may be determined from among images that are the lowest layer in the GOP. For example, only the zeroth image that is layer 1 may be determined as the reference image.

In an embodiment, whether to reduce each of the plurality of images within the GOP may be determined. For example, images that use intra-prediction may be decoded in their original size without being scaled down, and other images may be scaled down and decoded. For example, images that use intra-prediction and images included in a specific layer (e.g., the lowest layer) may be decoded in their original size without being scaled down, and other images may be scaled down and decoded.

In an embodiment, to decode the current image, the image decoding device may use a first reference image included in a first reference picture list for the current picture, which includes at least one picture having a picture order count (POC) value less than a POC value of the current image. Alternatively, to decode the current image, the image decoding device may use a second reference image included in a second reference picture list for the current picture, which includes at least one picture having a POC value greater than a POC value of the current image.

On the other hand, the present disclosure is not limited to the disclosed examples, both the first reference image and the second reference image may be images included in the first reference picture list of the current image, or may be images included in the second reference picture list of the current image.

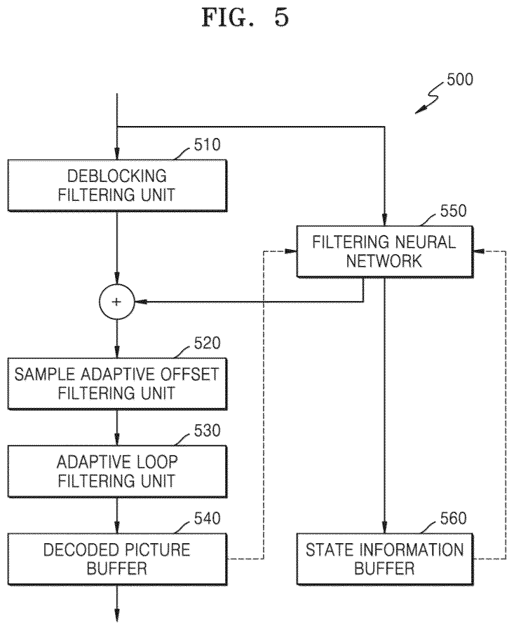

FIG. 5 is a diagram illustrating an in-loop filtering operation according to an embodiment of the present disclosure.

In an embodiment, the in-loop filtering unit 135 of the image encoding device 110 or the in-loop filtering unit 165 of the image decoding device 150 (hereinafter, an in-loop filtering unit 500) may include at least one of a deblocking filtering unit 510, a sample adaptive offset filtering unit 520, and an adaptive loop filtering unit 530.

In an embodiment, the deblocking filtering unit 510 may determine whether to perform deblocking filtering and may perform deblocking filtering. The sample adaptive offset filtering unit 520 may determine whether to perform sample adaptive offset filtering and may perform sample adaptive offset filtering. The adaptive loop filtering unit 530 may determine whether to perform adaptive loop filtering and may perform adaptive loop filtering.

In an embodiment, the in-loop filtering unit 500 may store, in a decoded picture buffer 540, a filtered picture that is filtered through the deblocking filtering unit 510, the sample adaptive offset filtering unit 520, and the adaptive loop filtering unit 530. Accordingly, at least one picture stored in the decoded picture buffer 540 may have undergone in-loop filtering and may be used as a reference picture for generating a prediction block in inter-prediction.

In an embodiment, the deblocking filtering may be filtering applied to a boundary of a transform block by using a deblocking filter to reduce blocking artifacts that occur during the process of performing transformation, prediction, and quantization.

In an embodiment, the filter length for deblocking filtering may be determined based on image components or the size of minimum transform blocks on both sides. A 4-tap, 8-tap, or 14-tap filter may be applied to transform block for luma samples, and a 6-tap filter may be applied to transform block for chroma samples. On the other hand, the size or length of the tap used for the deblocking filtering is not limited to the disclosed examples.

In an embodiment, the filter length for deblocking filtering may be determined based on the smoothness or boundary condition of boundaries between transform blocks. For example, when performing filtering on image data, the image decoding device 150 may identify an area including high-dispersion samples as an edge and may not perform deblocking filtering, so as to prevent the edge of an object from being blurred. The image decoding device 150 may calculate the smoothness within the image data or identify whether the boundary condition is satisfied, and may filter the boundary of the transform block only when the boundary of the transform block is identified as being flat. The boundary condition may differ depending on whether the boundary is a vertical boundary or a horizontal boundary, whether the transform block is for luma samples, or whether the transform block is for chroma samples. The image decoding device 150 may obtain, from a bitstream, information associated with the boundary condition, and the boundary condition may be preset. In addition, a filter coefficient associated with the deblocking filtering may be preset.

In an embodiment, the sample adaptive offset filtering may be filtering that classifies samples of neighboring blocks and uses offsets for the classified samples, so as to reduce ringing artifacts. For example, the sample adaptive offset filtering may be filtering that reduces an error between a reconstructed image and an original image by adding an offset to at least one sample included in an image on which the deblocking filtering has been performed.

In an embodiment, the sample adaptive offset filtering may determine sample characteristics within a block as one of using no sample adaptive offset filtering, performing edge offset filtering, or performing band offset filtering.

In an embodiment, the edge offset filtering is filtering that is performed when it is identified that a block has an edge in a specific direction and there is an error for samples in an edge direction. The image decoding device 150 may perform the edge offset filtering on the block by obtaining a class corresponding to a block and four edge offset values for the purpose of edge offset filtering.

In an embodiment, the band offset filtering is filtering that classifies samples within a block into brightness bands having similar brightness values and uses offsets for a plurality of consecutive bands. The image decoding device 150 may perform the band offset filtering by obtaining information about a start period of a band and an offset value for each of a plurality of bands so as to obtain information about the plurality of bands.

In an embodiment, the image decoding device 150 may perform sample adaptive offset filtering on the current block by using information about sample adaptive offset filtering for neighboring blocks. For example, the image decoding device 150 may perform sample adaptive offset filtering on the current block by using information about sample adaptive offset filtering for an upper block or a left block.

In an embodiment, the adaptive loop filtering may be filtering that is applied to the current block by using a filter adaptively determined or obtained based on characteristics of the current block. The adaptive loop filtering may be filtering that is performed by using at least one predefined filter set, at least one adaptive parameter set (APS) filter set obtained from an APS, and a filter determined based on at least one of classes of the current block.

In an embodiment, the adaptive loop filtering may be filtering that determines and uses one filter of a predefined filter set or at least one APS filter set obtained from an APS, based on information obtained from a bitstream. In addition, the filter used in the adaptive loop filtering may be determined as one of a plurality of classes, based on characteristics such as directionality and activity of samples within the current block. On the other hand, characteristics such as directionality and activity of samples within the current block may be determined by using a gradient for the current block.

On the other hand, the in-loop filtering unit 500 is not limited to the disclosed examples, and may additionally process an image in parallel with at least one filtering unit among the deblocking filtering unit 510, the sample adaptive offset filtering unit 520, and the adaptive loop filtering unit 530, or additional filtering may be performed through a configuration added before or after the at least one filtering unit. For example, the in-loop filtering unit 500 may use an output image obtained from a filtering neural network, so as to obtain an image in which in-loop filtering has been applied to the current image.

In an embodiment, the in-loop filtering unit 500 may include a filtering neural network 550 that additionally filters the image by using state information. For example, the filtering neural network 550 may additionally process the reconstructed image in parallel with the deblocking filtering unit.

In an embodiment, the filtering neural network 550 may be a neural network that performs filtering on the current image by using state information corresponding to each of the reconstructed image of the current image, at least one image included in the decoded picture buffer 540, and at least one image included in the state information buffer 560.

In an embodiment, the filtering neural network 550 may generate an output image for the current image, based on obtaining the information corresponding to the current image. For example, the filtering neural network 550 may obtain, as the information corresponding to the current image, at least one of the reconstructed image of the current image, the prediction image of the current image, the first reference image of the current image, the second reference image of the current image, at least one quantization parameter for the current image, and division information about the current image.

In an embodiment, the in-loop filtering unit 500 may obtain an image, in which the in-loop filtering has been applied, to the current image by inputting, to the filtering neural network 550, the information corresponding to the current image. For example, the filtering neural network 550 may generate a feature map corresponding to the current image, based on receiving the information corresponding to the current image, and may generate an output image from the feature map corresponding to the current image. In addition, the in-loop filtering unit 500 may obtain an image, in which the in-loop filtering has been applied to the current image, by using the output image.

In an embodiment, the in-loop filtering unit 500 may determine or generate layer information to be used for at least one layer within the filtering neural network by using state information corresponding to at least one reference image included in the state information buffer 560. For example, the in-loop filtering unit 500 may determine or generate a kernel or an attention map to be used in the filtering neural network, based on first state information corresponding to the first reference image and second state information corresponding to the second reference image, which are stored in the state information buffer 560.

In an embodiment, the in-loop filtering unit 500 may input the information corresponding to the current image to the filtering neural network 550 based on the layer information. The in-loop filtering unit 500 may obtain an output image for the current image from the filtering neural network 550, based on inputting, to the filtering neural network 550, the information corresponding to the current image.

In an embodiment, the image decoding device 150 may perform an addition operation on the deblock-filtered image obtained from the deblocking filtering unit 510 and the output image obtained from the filtering neural network 550. The addition operation may refer to an element-wise sum. The image decoding device 150 may input, to the sample adaptive offset filtering unit 520, a result of performing the addition operation on the deblock-filtered image and the output image. The result of performing the addition operation on the deblock-filtered image and the output image may be stored in the decoded picture buffer 540 through the sample adaptive offset filtering unit 520 and the adaptive loop filtering unit 530. In addition, the image, which is stored in the decoded picture buffer 540 through the sample adaptive offset filtering unit 520 and the adaptive loop filtering unit 530, may be used as the reference image, and the state information corresponding to the image stored in the decoded picture buffer 540 may be stored in the state information buffer 560.

On the other hand, the configuring of the filtering neural network 550 in parallel with the deblocking filtering unit is only an example, and the present disclosure is not limited to the disclosed examples. The filtering neural network 550 may be configured in parallel with or connected in series with a plurality of filtering units. In addition, in addition to simply performing the addition operation on the deblock-filtered image and the output image obtained from the filtering neural network 550, an image obtained by performing a weighted sum by assigning a predefined weight to each of the deblock-filtered image and the output image may be input as an input of the sample adaptive offset filtering unit 520. The filtering neural network 550 may be appropriately trained according to a location where the filtering neural network 550 is placed.

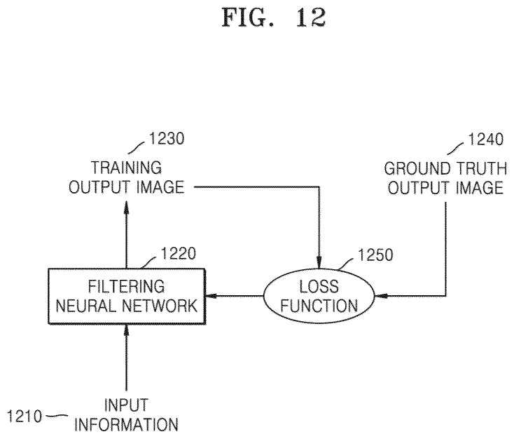

Hereinafter, the training of the filtering neural network 550 is described in detail with reference to FIG. 12.

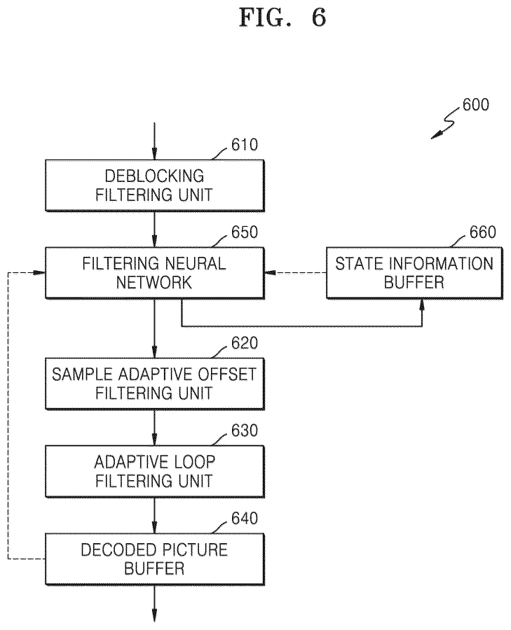

FIG. 6 is a diagram illustrating an in-loop filtering operation according to an embodiment of the present disclosure.

In an embodiment, the in-loop filtering unit 135 of the image encoding device 110 or the in-loop filtering unit 165 of the image decoding device 150 (hereinafter, an in-loop filtering unit 600) may include at least one of a deblocking filtering unit 610, a sample adaptive offset filtering unit 620, and an adaptive loop filtering unit 630.

In an embodiment, the deblocking filtering unit 610, the sample adaptive offset filtering unit 620, and the adaptive loop filtering unit 630 may respectively correspond to the deblocking filtering unit 510, the sample adaptive offset filtering unit 520, and the adaptive loop filtering unit 530 of FIG. 5, and therefore, the same description thereof is omitted.

In an embodiment, the in-loop filtering unit 600 may additionally process an image in parallel with at least one filtering unit among the deblocking filtering unit 610, the sample adaptive offset filtering unit 620, and the adaptive loop filtering unit 630, or additional filtering may be performed through a configuration added before or after the at least one filtering unit. For example, the in-loop filtering unit 600 may include a filtering neural network that generates an output image that is used to obtain an in-loop filtered image.

In an embodiment, the filtering neural network 650 may be a neural network that performs filtering by using a reconstructed image, a deblock-filtered image obtained by processing the reconstructed image in the deblocking filtering unit, at least one image included in the decoded picture buffer 640, and state information included in a state information buffer 660.

In an embodiment, the filtering neural network 650 may generate an output image for the current image, based on the obtaining of information corresponding to the current image. For example, the filtering neural network 650 may obtain, as the information corresponding to the current image, at least one of a reconstructed image of the current image, a deblock-filtered image of the current image, a prediction image of the current image, a first reference image of the current image, a second reference image of the current image, at least one quantization parameter for the current image, and division information about the current image.

In an embodiment, the in-loop filtering unit 600 may generate or determine layer information to be used in the filtering neural network by using state information corresponding to a reference image included in the state information buffer 660. For example, the in-loop filtering unit 600 may generate or determine a kernel or an attention map to be used in the filtering neural network, based on the state information stored in the state information buffer 660.

In an embodiment, the in-loop filtering unit 600 may input the information corresponding to the current image to the filtering neural network 650 based on the layer information. The in-loop filtering unit 600 may obtain an output image for the current image from the filtering neural network 650, based on inputting, to the filtering neural network 650, the information corresponding to the current image.

In an embodiment, the in-loop filtering unit 600 may input, to the sample adaptive offset filtering unit 620, the output image obtained from the filtering neural network 650. The output image is an image in which in-loop filtering has been applied through the sample adaptive offset filtering unit 620 and the adaptive loop filtering unit 630, and may be stored in the decoded picture buffer 640.

On the other hand, the filtering neural network 650 is configured to be connected in series after deblocking filtering, which is only an example, but the present disclosure is not limited to the disclosed examples. For example, the filtering neural network 650 may be positioned between the sample adaptive offset filtering unit 620 and the adaptive loop filtering unit 630, and may be appropriately trained according to the positioned location.

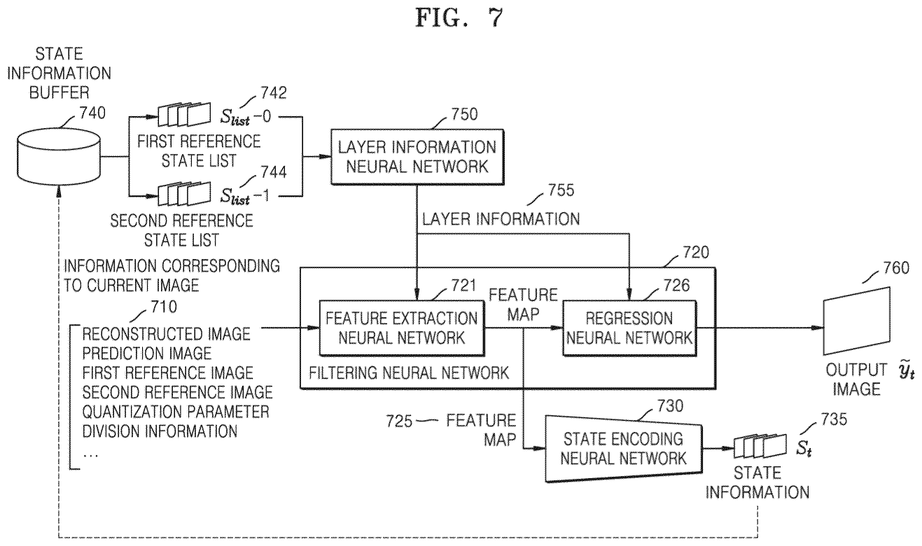

FIG. 7 is a diagram for describing the process of generating the output image from the filtering neural network, according to an embodiment of the present disclosure.

In an embodiment, the in-loop filtering unit may include a filtering neural network 720. The filtering neural network 720 may include a feature extraction neural network 721 and a regression neural network 726. In addition, the filtering neural network 720 may be a neural network that generates an output image that is used to obtain an in-loop filtered image.

In an embodiment, when a first reference image or a second reference image is used to decode a current image, the filtering neural network 720 may use first state information corresponding to the first reference image or second state information corresponding to the second reference image. For example, the filtering neural network 720 may use only the first reference image to decode the current image, and in this case, only the first state information may be used.

On the other hand, the first state information corresponding to the first reference image may be obtained from a feature map corresponding to the first reference image. On the other hand, the second state information corresponding to the second reference image may be obtained from a feature map corresponding to the second reference image.

In an embodiment, the first reference image for the current image or the second reference image for the current image may be an image included in a first reference picture list or a second reference picture list. For example, the first reference image may be included in the first reference picture list, and the second reference image may be included in the second reference picture list. Alternatively, the first reference image and the second reference image may be images included in the second reference picture list. Alternatively, the first reference image and the second reference image may be images included in the first reference picture list. However, the present disclosure is not limited to the disclosed examples.

In an embodiment, the image decoding device may determine the filtering neural network 720 for filtering the current image by using first state information that is included in a first reference state list 742 and corresponds to the first reference image included in the first reference picture list. For example, the image decoding device may input the first state information and the second state information to a layer information neural network 750. The image decoding device may generate layer information to be used in at least one neural network within the filtering neural network 720, based on inputting the first state information and the second state information to the layer information neural network 750.

On the other hand, for the convenience of explanation, an example in which only the first reference image or the second reference image is used as the reference image for the current image has been described, but the present disclosure is not limited to the disclosed examples. State information corresponding to reference blocks included in at least one reference image to be used to predict the current image may be input to the layer information neural network, and layer information for the current image may be generated by using at least one piece of input state information. For example, for a first current block and a second current block included in the current image, when the first current block is predicted by using a first reference block included in a first reference image and the second current block is predicted by using a second reference block included in a second reference image and a third reference block included in a third reference image, the current image may generate layer information for the current image, based on inputting, to the layer information neural network 750, state information corresponding to the first reference block, state information corresponding to the second reference block, and state information corresponding to the third reference block.

In an embodiment, the image decoding device may generate or obtain layer information 755 that is used in at least one layer within the filtering neural network 720, based on first state information obtained from a feature map corresponding to the first reference image for the current image or second state information obtained from a feature map corresponding to the second reference image for the current image.

In an embodiment, the filtering neural network may include a feature extraction neural network that extracts features of the current image from information corresponding to the current image and generates a feature map corresponding to the current image, and a regression neural network that is used to obtain, from the feature map corresponding to the current image, an image in which in-loop filtering has been applied to the current image. The layer information 755 may include at least one of a kernel and an attention map to be used in at least one layer included in the feature extraction neural network 721 and a regression neural network 726.

In an embodiment, the filtering neural network may include at least one of a deep neural network, a convolution neural network, and a transformer neural network.

In an embodiment, the filtering neural network 720 may generate an output image 760 for the current image, based on obtaining information corresponding to the current image. For example, the filtering neural network 720 may obtain, as information 710 corresponding to the current image, at least one of a reconstructed image of the current image, a deblock-filtered image of the current image, a prediction image of the current image, a first reference image of the current image, a second reference image of the current image, at least one quantization parameter for the current image, and division information about the current image. On the other hand, the present disclosure is not limited to the disclosed examples, at least one of the sample adaptive offset filtered image and the adaptive loop filtered image of the current image may be obtained as the information 710 corresponding to the current image according to the structure of the in-loop filtering unit.

In an embodiment, the image decoding device may input the information 710 corresponding to the current image to the filtering neural network 720. The image decoding device may input the information corresponding to the current image to at least one layer within the filtering neural network. In the image decoding device, the feature extraction neural network 721 included in the filtering neural network 720 may obtain, generate, or extract a feature map 725 corresponding to the current image by obtaining the information 710 corresponding to the current image. The regression neural network 726 included in the filtering neural network 720 may obtain the feature map 725 as input from the feature extraction neural network 721. The image decoding device may generate or obtain the output image 760, based on inputting the feature map 725 to the regression neural network 726.

In an embodiment, the image decoding device may obtain an intermediate feature map 725 corresponding to the current image from the filtering neural network 720 and may input the intermediate feature map 725 to a state encoding neural network. For example, the image decoding device may input, to the state encoding neural network 730, the intermediate feature map 725 obtained or extracted from the feature extraction neural network 721 included in the filtering neural network 720.

In an embodiment, the image decoding device may generate or obtain state information 735 for the current image from the state encoding neural network 730 by inputting, to the state encoding neural network 730, the feature map 725 obtained from the filtering neural network 720.

In an embodiment, the state information 735 for the current image may be information obtained from the feature map corresponding to the current image. Because the state information 735 for the current image includes abstract information rather than high-resolution information, less memory capacity than information about the image stored in the decoded picture buffer may be required. In addition, because the state information 735 is an output of hidden layers trained by optimizing a loss function by using a gradient descent method, the state information 735 may be abstract information that is unclear as to what the information exactly represents.

In an embodiment, the state information 735 for the current image may have a resolution lower than a resolution of the current image, depending on characteristics representing abstract information for the current image.

In an embodiment, the image decoding device may store the generated or obtained state information 735 in the state information buffer 740. When the current image is used as the reference image, the image decoding device may also use the state information 735 for the current image which is stored in the state information buffer 740.

On the other hand, for convenience of explanation of the present disclosure, the process of obtaining the output image for the current image by inputting, to the filtering neural network, the information corresponding to the current image, and obtaining current state information corresponding to the current image has been mainly described, but the present disclosure is not limited to the disclosed examples, and the same operation may be performed by inputting, to the filtering neural network, information corresponding to the first reference image or the second reference image.

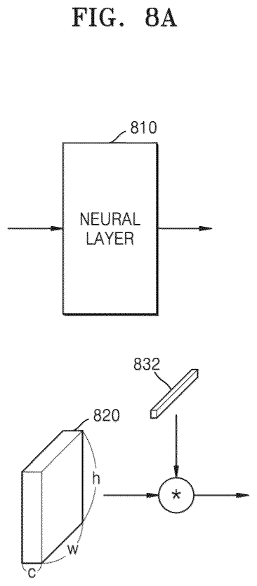

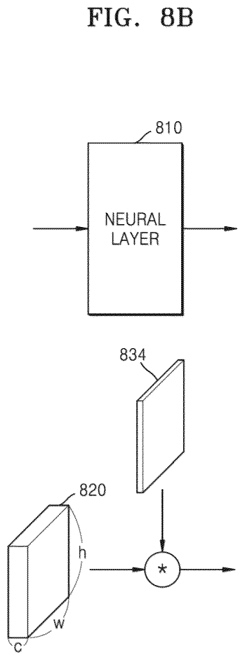

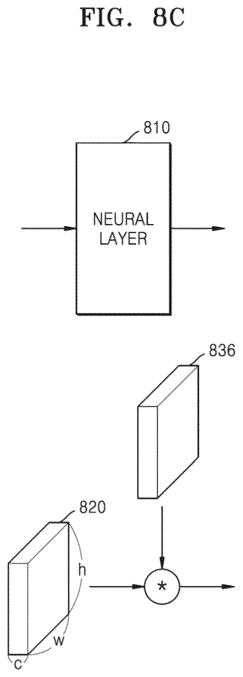

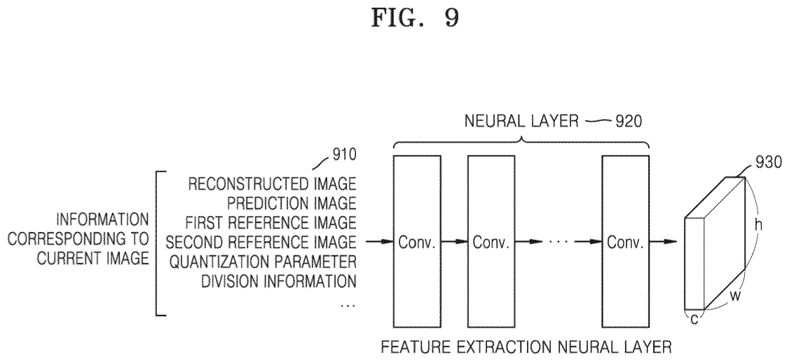

Hereinafter, layer information applied to the filtering neural network is described in detail with reference to FIGS. 8A to 8C. In addition, the neural network according to the present disclosure is described in detail with reference to FIGS. 9 to 11B.

FIGS. 8A to 8C are diagrams for describing a filtering neural network using layer information, according to an embodiment of the present disclosure.

In an embodiment, the image decoding device may configure a filtering neural network based on layer information. For example, the image decoding device may generate or obtain an attention map as layer information by using a layer information neural network. The attention map may be at least one of a channel attention map 832, a spatial attention map 834, and a full attention map 836. The channel attention map 832 may be a one-dimensional attention map, the spatial attention map 834 may be a two-dimensional attention map, and the full attention map 836 may be a three-dimensional attention map.

Referring to FIG. 8A, a feature map may be output by using the channel attention map 832 generated as layer information in at least one neural layer 810 included in the filtering neural network. Hereinafter, the output for the neural layer 810 may be referred to as an output feature map.

In an embodiment, the neural layer 810 included in the filtering neural network may be a layer that performs an attention operation by using the channel attention map 832 obtained, generated, or output through a layer information neural network. The neural layer 810 may be a simple illustration indicating that the channel attention map 832 is applied to a feature map on which only a convolution operation has been performed.

In an embodiment, the neural layer 810 may perform a convolution operation and an attention operation. For example, the image decoding device may perform a convolution operation by applying weights and biases to an input feature map by using a convolution kernel through the neural layer 810, and may perform an attention operation by applying element-wise multiplication with an attention map to the result of performing the convolution operation. By performing the convolution operation and the attention operation, the output feature map may be generated or output through one neural layer 810. This may be expressed as Equation 1 below.

$$Output feature map = Activation ( Weight * Input feature map + Bias ) \times ( Attention map ) \qquad [ Equation 1 ]$$

In an embodiment, the activation may represent an activation function and may be one of a sigmoid function, a rectified linear unit function (ReLu function), a hyperbolic tangent function (Tanh function), and a softmax function according to the design of the neural network, but the present disclosure is not limited to the disclosed examples, and other activation functions may be used as technology advances.

In an embodiment, the channel attention map 832 may be a map that is used to emphasize a portion to be concentrated or focused on one dimensional direction among a height direction, a width direction, and a channel direction for the result 820 of performing the convolution operation on the input feature map. In addition, when the channel attention map 832 has a different size in a certain dimension from the result 820 of performing the convolution operation on the input feature map, the channel attention map 832 may be applied after being adjusted to the same or similar size as the result of performing the convolution operation on the input feature map. For example, when the result 820 of performing the convolution operation on the input feature map is expressed in the size of C*W*H and the channel attention map 832 is c′*1*1, the channel attention map 832 may be adjusted to the size of C*1*1 and applied to all W*H channels.

Referring to FIG. 8B, a feature map may be output by using the spatial attention map 834 generated as layer information in at least one neural layer 810 included in the filtering neural network.

In an embodiment, the neural layer 810 included in the filtering neural network may be a layer that performs an attention operation by using the spatial attention map 834 obtained, generated, or output through a layer information neural network. Hereinafter, because the neural layer 810 of FIG. 8B only differs from the neural layer 810 of FIG. 8A in that the spatial attention map 834 is used as the attention map, the same redundant description thereof is omitted.

In an embodiment, the spatial attention map 834 may be a map that is used to emphasize a portion to be concentrated or focused on two dimensional directions among a height direction, a width direction, and a channel direction for the result 820 of performing the convolution operation on the input feature map. In addition, when the spatial attention map 834 has a different size in a certain dimension from the result 820 of performing the convolution operation on the input feature map, the spatial attention map 834 may be applied after being adjusted to the same or similar size as the result 820 of performing the convolution operation on the input feature map. For example, when the result 820 of performing the convolution operation on the input feature map is expressed in the size of C*W*H and the spatial attention map 834 is 1*w′*h′, the spatial attention map 834 may be adjusted to the size of 1*W*H and applied to all C spaces with the size of W*H.

Referring to FIG. 8C, a feature map may be output by using the full attention map 836 generated as layer information in at least one neural layer 810 included in the filtering neural network.

In an embodiment, the neural layer 810 included in the filtering neural network may be a layer that performs an attention operation by using the full attention map 836 obtained, generated, or output through a layer information neural network. Hereinafter, because the neural layer 810 of FIG. 8C only differs from the neural layer 810 of FIG. 8A in that the full attention map 836 is used as the attention map, the same redundant description thereof is omitted.

In an embodiment, the full attention map 836 may be a map that is used to emphasize a portion to be concentrated or focused on a three-dimensional direction among a height direction, a width direction, and a channel direction for the result 820 of performing the convolution operation on the input feature map. In addition, when the full attention map 836 has a different size in a certain dimension from the result 820 of performing the convolution operation on the input feature map, the full attention map 836 may be applied after being adjusted to the same or similar size as the result 820 of performing the convolution operation on the input feature map. For example, when the intermediate feature map, which is the result 820 of performing the convolution operation on the input feature map, is expressed in the size of C*W*H and the full attention map 836 is c′*w′*h′, the full attention map 836 may be adjusted to the size of C*W*H, and for the sample of each location of the result 820 of performing the convolution operation on the input feature map, the output feature map may be obtained or generated by performing element-wise multiplication by using the corresponding sample of the full attention map 836.

In an embodiment, the full attention map 836 may be generated in the same or similar size as the intermediate feature map for performing element-wise multiplication.

On the other hand, the attention map is not limited to the examples disclosed in FIGS. 8A to 8C, and other methods may be applied.

FIG. 9 is a diagram illustrating a structure of a feature extraction neural network included in a filtering neural network, according to an embodiment of the present disclosure.

Referring to FIG. 9, the feature extraction neural network may obtain, as input, information 910 corresponding to a current image, including at least one of a reconstructed image, a deblock-filtered image, a prediction image, a first reference image, a second reference image, at least one quantization parameter, and division information. In addition, the feature extraction neural network may output an intermediate feature map 930, based on obtaining the information 910 corresponding to the current image.

In an embodiment, the feature extraction neural network may be a deep neural network, a convolution neural network, and a transformer neural network, or may be a combination of a deep neural network, a convolution neural network, and a transformer neural network. On the other hand, although FIG. 9 illustrates an example in which the feature extraction neural network is a convolution neural network, the present disclosure is not limited thereto, and other neural network models may be used.

In an embodiment, the feature extraction neural network may include at least one neural layer 920. On the other hand, for convenience of explanation, the at least one neural layer 920 included in the feature extraction neural network is illustrated as including only a convolution layer, but the present disclosure is not limited to the disclosed examples, and the at least one neural layer 920 may be configured to include at least one of a convolution layer, an activation layer, an attention layer, a pooling layer, a dropout layer, a batch normalization layer, a recurrent layer, and an embedding layer. On the other hand, the at least one neural layer 920 may be referred to as at least one layer.

In an embodiment, the feature extraction neural network may be a neural network including a structure in which a combination of a convolution layer, an activation layer, and an attention layer is repeated.

In an embodiment, the at least one layer included in the feature extraction neural network may include at least one neural layer for generating a feature map corresponding to a current image. The feature map corresponding to the current image may have the same resolution as the resolution of the current image. Alternatively, the feature map corresponding to the current image may have a resolution higher or lower than a resolution of the current image.

In an embodiment, the at least one layer included in the feature extraction neural network may include at least one down-sampling layer. The feature extraction neural network may include at least one down-sampling layer for generating the feature map corresponding to the current image, which has a resolution lower than a resolution of the current image.

In an embodiment, the image decoding device may obtain the feature map corresponding to the current image, based on inputting, to the feature extraction neural network, information corresponding to the current image. In an embodiment, the image decoding device may obtain the feature map corresponding to the current image in response to inputting, to the feature extraction neural network, the information corresponding to the current image. In addition, state information for the current image may be obtained from the feature map corresponding to the current image and may have a resolution lower than a resolution of the current image. This may be based on the down-sampling layer included in the feature extraction neural network.

On the other hand, the size of an intermediate feature map generated as the output of the feature extraction neural network may be expressed as c*w*h, where w and h may be different from W and H as the size of the image, respectively.

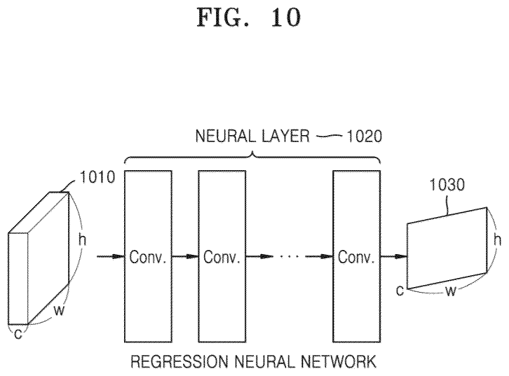

FIG. 10 is a diagram illustrating a structure of a regression neural network included in a filtering neural network, according to an embodiment of the present disclosure.

Referring to FIG. 10, the regression neural network may obtain, as input, a feature map 1010 obtained from a feature extraction neural network. In addition, the regression neural network may generate an output image 1030 to be used to obtain an in-loop filtered image, based on the obtaining of the feature map 1010.

In an embodiment, the regression neural network may be a deep neural network, a convolution neural network, and a transformer neural network, or may be a combination of a deep neural network, a convolution neural network, a recurrent neural layer, and a transformer neural network. On the other hand, although FIG. 10 illustrates an example in which the regression neural network is a convolution neural network, the present disclosure is not limited thereto, and other neural network models may be used.

In an embodiment, the regression neural network may include at least one neural layer 1020. On the other hand, for convenience of explanation, the at least one neural layer 1020 included in the regression neural network is illustrated as including only a convolution layer, but the present disclosure is not limited to the disclosed examples, and the at least one neural layer 1020 may be configured to include at least one of a convolution layer, an activation layer, an attention layer, a pooling layer, a dropout layer, a batch normalization layer, a recurrent layer, and an embedding layer. On the other hand, the at least one neural layer 1020 may be referred to as at least one layer.

In an embodiment, the regression neural network may be a neural network including a structure in which a combination of a convolution layer, an activation layer, and an attention layer is repeated.

In an embodiment, the at least one layer included in the regression neural network may receive a feature map corresponding to a current image as input and generate an output image. The resolution of the feature map corresponding to the current image may be equal to the resolution of the output image. The resolution of the feature map corresponding to the current image may be lower or higher than the resolution of the output image.

In an embodiment, the at least one layer included in the regression neural network may include at least one up-sampling layer. The regression neural network may include at least one up-sampling layer for generating an output image that has a resolution higher than a resolution of the feature map corresponding to the current image. For example, when the feature extraction neural network includes at least one down-sampling layer for generating the feature map corresponding to the current image, which has a resolution lower than a resolution of the current image, the regression neural network may include at least one up-sampling layer for generating the output image that has a resolution higher than a resolution of the feature map corresponding to the current image.

In an embodiment, the regression neural network may generate the output image to be used to obtain an image in which in-loop filtering has been applied to the current image, based on obtaining the feature map corresponding to the current image. The image decoding device may obtain an in-loop filtered image for the current image, based on performing an addition operation on the output image obtained from the regression neural network and a deblock-filtered image of the current image.

In an embodiment, the image decoding device may obtain the output image from the regression neural network that obtains the feature map corresponding to the current image as input. In addition, the output image may have a resolution higher than a resolution of the feature map corresponding to the current image.

On the other hand, the size of the output image 1030 generated as the output of the regression neural network may be expressed as C*W*H, where W and H represents the size of the image and c is information representing a color channel. For example, the color channel may be information representing each of R channel, G channel, and B channel (RGB channels) or each of Y channel, U channel, and V channel (YUV channels).

In an embodiment, the state encoding neural network may be similar to the regression neural network of FIG. 10. For example, the state encoding neural network may obtain the same input as the regression neural network of FIG. 10. However, the output of the state encoding neural network may be state information about the image. However, the present disclosure is not limited to the disclosed examples.

In an embodiment, the state encoding neural network may include at least one of a deep neural network, a convolution neural network, and a transformer neural network. To reduce the size of data by taking into account abstract characteristics of the state information, the state encoding neural network may include a down-sampling layer, such as a stride convolution layer and a pooling layer.

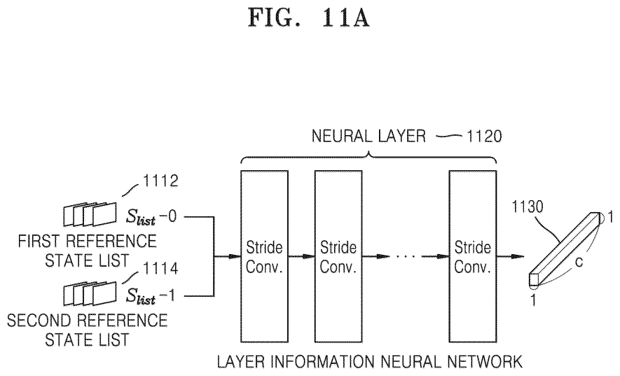

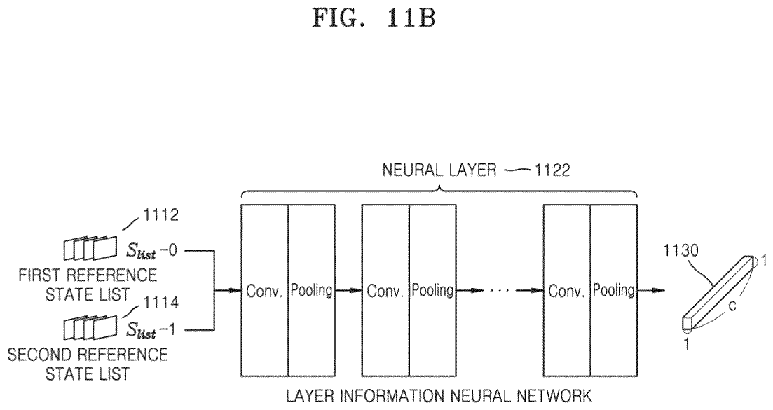

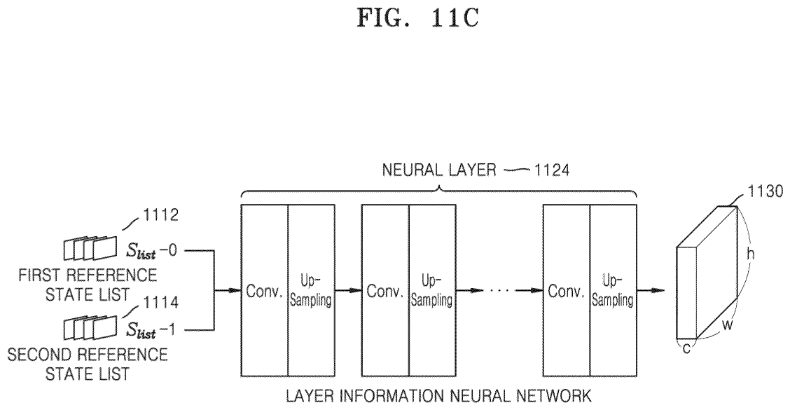

FIGS. 11A to 11C are diagrams illustrating a structure of a layer information neural network according to an embodiment of the present disclosure.

Referring to FIGS. 11A to 11C, the layer information neural network may obtain, as input, state information corresponding to images stored in a state information buffer. For example, layer information neural networks 1120, 1122, and 1124 may obtain state information corresponding to a reference image for a current image, so as to generate or output layer information 1130 for the current image. Hereinafter, the reference image may be the first reference image and/or the second reference image of the present disclosure.

In an embodiment, the image decoding device may generate or output layer information by inputting, to the layer information neural networks 1120, 1122, and 1124, pieces of state information corresponding to the reference blocks to be used to generate a prediction block for blocks included in the current image. Accordingly, the image decoding device may generate or output layer information by using all or part of at least one piece of state information corresponding to at least one reference image that is used to perform prediction on the current image. On the other hand, the layer information may be generated in frame units, slice units, tile units, maximum CUs, CUs, or prediction units, but the present disclosure is not limited to the disclosed examples.

However, although the example of using the state information corresponding to the current block to predict the current block of the prediction unit has been described, the present disclosure is not limited to the disclosed examples, and the layer information may be generated, determined, or output on in frame units. For example, when the layer information is generated in frame units, the layer information may be generated by using state information corresponding to each of reference blocks for blocks included in a frame.

In an embodiment, when inter-prediction is performed through a single direction reference, such as a forward reference or a backward reference, so as to generate a prediction block for a current block included in a current image, the image decoding device may obtain, as the inputs of the layer information neural networks 1120, 1122, and 1124, state information included in a first reference state list 1112 corresponding to a reference block included in a reference image within a first reference picture list or state information included in a second reference state list 1114 corresponding to a reference block included in a reference image within a second reference picture list.

In an embodiment, when bi-prediction, such as bi-direction reference, 2 forward reference, or 2 backward reference, is performed to generate a prediction block for a current block included in a current image, the image decoding device may generate or output layer information, based on the inputting, to the layer information neural networks 1120, 1122, and 1124, of pieces of state information corresponding to two reference blocks respectively included in two reference images among reference images within a first reference picture list and a second reference picture list.

In an embodiment, at least one image included in the first reference picture list that is used to predict the current image may include the first reference image, and the state information corresponding to the first reference image may be referred to as first state information. In addition, at least one image included in the second reference picture list that is used to predict the current image may include the second reference image, and the state information corresponding to the second reference image may be referred to as second state information. In addition, the first reference state list may be a list including pieces of state information respectively corresponding to images included in the first reference picture list. The second reference state list may be a list including pieces of state information respectively corresponding to images included in the second reference picture list.

In an embodiment, the layer information neural networks 1120, 1122, and 1124 may output the layer information 1130 to be applied to at least one layer within the filtering neural network, based on the obtaining of the pieces of state information corresponding to the images stored in the state information buffer as input.

In an embodiment, referring to FIG. 11A, the layer information neural network may output an attention map or a kernel with the size of c*1*1. For example, the layer information neural network 1120 may include at least one down-sampling layer. The at least one down-sampling layer may include at least one stride convolution layer, and the layer information neural network may output a channel attention map or a kernel.

In an embodiment, referring to FIG. 11B, the layer information neural network 1122 may output an attention map or a kernel with the size of c*1*1. For example, the layer information neural network may include at least one down-sampling layer. The at least one down-sampling layer may include at least one pooling layer. The layer information neural network according to FIG. 11B may output a channel attention map or a kernel.

In an embodiment, referring to FIG. 11C, the layer information neural network 1124 may output an attention map with the size of c*w*h. For example, the layer information neural network may include at least one up-sampling layer. The at least one up-sampling layer may include at least one of an interpolation layer, a deconvolution layer, and a pixel shuffle layer. The layer information neural network may output a spatial attention map or a full attention map.

In an embodiment, the layer information 1130 may include at least one of a convolution kernel and an attention map. For example, the layer information neural network may output only the convolution kernel, may output only the attention map, or may output both the convolution kernel and the attention map. In addition, the layer information 1130 may include layer information 1130 to be applied to each of the feature extraction neural network and the regression neural network included in the filtering neural network, and the layer information 1130 to be applied to the feature extraction neural network may be different from the layer information 1130 to be applied to the regression neural network.

In an embodiment, the layer information neural network may be a deep neural network, a convolution neural network, and a transformer neural network, or may be a combination of a deep neural network, a convolution neural network, a recurrent neural layer, and a transformer neural network. On the other hand, although FIG. 11A illustrates an example in which the layer information neural network is a convolution neural network, the present disclosure is not limited thereto, and other neural network models may be used.

In an embodiment, the layer information neural network may include at least one neural layer 1120, 1122, and 1124. On the other hand, for convenience of explanation, the at least one neural layer 1120 included in the layer information neural network is illustrated as including only a stride convolution layer, but the present disclosure is not limited to the disclosed examples, and the at least one neural layer 1120 may be configured to include at least one of a convolution layer, an activation layer, an attention layer, a pooling layer, a dropout layer, a batch normalization layer, a recurrent layer, and an embedding layer.

For example, referring to FIGS. 11A to 11C, the layer information neural network may be a neural network including a structure in which a combination of a convolution layer and an activation layer is repeated, a neural network including a structure in which a combination of a convolution layer and a down-sampling layer is repeated, or a neural network including a structure in which a combination of a convolution layer and an up-sampling layer is repeated.

In an embodiment, the layer information neural network may include at least one of a stride convolution layer, a pooling layer, an interpolation layer, a deconvolution layer, and a pixel shuffle layer.

For example, the layer information neural network may be configured by using a down-sampling layer, such as a stride convolution layer and a pooling layer, taking into account the characteristics of a kernel having a relatively small size so as to perform scan on input state information. In addition, the layer information neural network may generate the kernel through the down-sampling layer.

For example, referring to FIGS. 11A to 11C, the layer information neural network may include a layer that performs down-sampling to generate a channel attention map having a size of c*1*1, and may include a layer that performs up-sampling to generate a full attention map 836 having a size of c*w*h. In addition, the layer information neural networks 1120, 1122, and 1124 may appropriately adjust the size of the output layer information 1130 by including the down-sampling layer or the up-sampling layer. On the other hand, the layer that performs down-sampling may include at least one of a stride convolution layer and a pooling layer, and the layer that performs up-sampling may include at least one of an interpolation layer, a deconvolution layer, and a pixel shuffle layer.

On the other hand, the stride convolution layer is a type of convolution layer, and when performing a convolution operation, may represent a layer with a stride size greater than 1, which represents an interval when the kernel moves the input feature map. Therefore, the size of the output feature map may be adjusted according to the stride size, and may be used to reduce the dimensionality of input data. In addition, because the use of the stride convolution layer reduces the amount of computation, the training and inference speed of the layer information neural network may be improved.

On the other hand, the pooling layer may be a layer that is used to reduce the dimensionality of the input and preserve important information, for example, by selecting and outputting the greatest value within a pooling window to emphasize the most prominent feature of the input, or by calculating and outputting an average of all values within the pooling window. In addition, the pooling layer may be a layer that reduces the computational complexity of the network and prevents overfitting by not including learnable weights.

On the other hand, the interpolation layer is a layer that is used to generate an output with increased dimensionality, compared to the input, and may be a layer that scales and increases the size of data obtained as input.

On the other hand, the deconvolution layer is a layer that expands the dimensionality of the image by performing the reverse process of the convolution operation, and may be a layer with learnable parameters.

On the other hand, the pixel shuffle layer is a layer that increases the resolution by rearranging pixels within the input, and may be a layer that increases the number of channels in the input and enlarges the size of the image by rearranging channels at a pixel level.

On the other hand, the present disclosure is not limited to the disclosed examples, and a kernel with the size of x*y*z (where x, y, and z are natural numbers) may be generated as the output of the layer information neural network, and an attention map with the size of c*w*h (where c, w, and h are natural numbers) may be generated as the output of the layer information neural network.

FIG. 12 is a diagram illustrating a method of training a filtering neural network, according to an embodiment of the present disclosure.

In an embodiment, a filtering neural network 1220 may be trained so that an in-loop filtered image obtained through an in-loop filtering unit becomes closer to an original image, based on obtaining information about at least two images having a reference relationship.

In an embodiment, the filtering neural network 1220 may output a training output image 1230 by obtaining, as input, information 1210 corresponding to at least two images having a reference relationship. The filtering neural network 1220 may be trained to make the training output image 1230 closer to a ground truth output image 1240 by comparing the training output image 1230 with the ground truth output image 1240 through a loss function 1250. On the other hand, the output image that makes the in-loop filtered image closer to the original image according to the structure of the in-loop filtering unit including the filtering neural network 1220 may be previously determined as the ground truth output image 1240.

In an embodiment, the filtering neural network, the state encoding neural network, and the layer information neural network may be trained together, based on inputting, to the filtering neural network, information corresponding to a first reference image or information corresponding to a second reference image and inputting, to the filtering neural network, information corresponding to a current image.

For example, the filtering neural network 1220 may receive the information corresponding to the first reference image and the information 1210 corresponding to the current image. The filtering neural network 1220 may generate a feature map corresponding to the first reference image by using the information corresponding to the first reference image. In addition, the encoding neural network may receive the feature map corresponding to the first reference image as input and may generate first state information for the first reference image. The filtering neural network 1220 may generate a feature map corresponding to the second reference image by using the information corresponding to the second reference image. In addition, the encoding neural network may receive the feature map corresponding to the second reference image as input and may generate second state information for the second reference image. In addition, the layer information neural network may generate layer information to be applied to the filtering neural network 1220 by using the first state information corresponding to the first reference image or the second state information corresponding to the second reference image. An output image may be generated as the training output image 1230 by inputting the information corresponding to the current image to the filtering neural network 1220 including at least one layer to which the generated layer information has been applied. The filtering neural network 1220 may be trained to make the training output image 1230 closer to the ground truth output image 1240 by comparing the training output image 1230 with the ground truth output image 1240.

On the other hand, for convenience of explanation, the filtering neural network 1220 is expressed and illustrated as being trained, but the feature extraction neural network, the regression neural network, the state encoding neural network, and the layer information neural network included in the filtering neural network of the present disclosure may be trained as a whole. Alternatively, the neural networks may be trained individually by presetting ground truth values for each of the feature extraction neural network, the regression neural network, the state encoding neural network, and the layer information neural network.

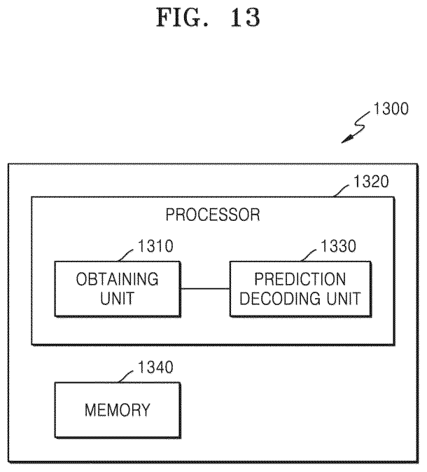

FIG. 13 is a block diagram illustrating a configuration of an image decoding device according to an embodiment of the present disclosure.

Referring to FIG. 13, an image decoding device 1300 may include at least one processor 1320 and memory 1340 storing instructions, and the at least one processor 1320 may include or implement an obtaining unit 1310 and a prediction decoding unit 1330. The obtaining unit 1310 illustrated in FIG. 13 may correspond to the entropy decoding unit 155 illustrated in FIG. 1, and the prediction decoding unit 1330 may correspond to the in-loop filtering unit 165 and the prediction decoding unit 170 illustrated in FIG. 1.

In an embodiment, the obtaining unit 1310 and the prediction decoding unit 1330 may be implemented by the at least one processor 1320. In an embodiment, the obtaining unit 1310 and the prediction decoding unit 1330 may operate according to instructions stored in memory.

In an embodiment, the memory 1340 may store input and output data of the obtaining unit 1310 and the prediction decoding unit 1330. In addition, the image decoding device 1300 may include a memory control unit that controls data input and output of the memory.

In an embodiment, the at least one processor 1320 is configured to control a series of processes so that the image decoding device 1300 operates according to embodiments described below, and may be implemented as one or more processors. The at least one processor 1320 may be circuitry, such as an SoC or an IC. The at least one processor 1320 may be one or more of a generic-purpose processor, such as a central processing unit (CPU), a microprocessor unit (MPU), an AP, or a digital signal processor (DSP), a dedicated graphics processor, such as a GPU or a vision processing unit (VPU), a dedicated artificial intelligence processor, such as an NPU, or a dedicated communication processor, such as a CP. When the at least one processor 1320 is one or more of a dedicated artificial intelligence processor, the dedicated artificial intelligence processor may be designed with a hardware structure specialized for processing a specific artificial intelligence model.

In an embodiment, the at least one processor 1320 may write data to the memory or read data stored in the memory 1340. In particular, the at least one processor 1320 may execute at least one instruction or a program stored in the memory 1340 to process data in accordance with predefined operation rules or artificial intelligence models. Accordingly, the at least one processor 1340 may perform the operations described in embodiments of the present disclosure, and the operations described as being performed by the image decoding device 1300 or the detailed elements (see 1310 and 1330 of FIG. 13) included in the image decoding device 1300 in the embodiments of the present disclosure may be considered as being performed by the processor unless otherwise stated.

In an embodiment, the memory 1340 may be configured to store various programs or data, and may be configured as a storage medium, such as one or more of a read-only memory (ROM), a random access memory (RAM), a hard disk, a compact disc read-only memory (CD-ROM), and a digital versatile disc (DVD), or a combination of storage media. The memory 1340 may be configured to be included in the at least one processor 1320, instead of being present separately. The memory 1340 may include a volatile memory, a non-volatile memory, or a combination of a volatile memory and a non-volatile memory. The memory 1340 may store a program or at least one instruction for performing operations according to embodiments described below. The memory 1340 may provide stored data to the processor in response to a request from the at least one processor 1320.

In an embodiment, the obtaining unit 1310 may obtain a bitstream generated as a result of encoding an image.

In an embodiment, the bitstream may include a result of encoding a current block. The bitstream may include pieces of information that is used to reconstruct the current block. The current block may be a maximum CU, a CU, a transform unit, a prediction unit, or a filtering unit divided from a current image to be decoded. In addition, the current block may be a block of a predefined location that is processed in an encoding or decoding operation being currently performed. A current sample may be any sample included in the current block.

In an embodiment, the prediction decoding unit 1330 may generate a prediction image so as to reconstruct the current image, and may generate or determine a prediction image for the current block, based on prediction information included in a bitstream corresponding to a level of at least one of a sequence parameter set, a picture parameter set, a video parameter set, a slice header, and a slice segment header. The prediction information may be information that is used to predict the current image.

In an embodiment, the obtaining unit 1310 may receive the bitstream from the image encoding device through the network.

In an embodiment, the obtaining unit 1310 may obtain a bitstream from a data storage medium including a magnetic medium, such as hard disk, floppy disk, and magnetic tape, an optical recording medium, such as CD-ROM and DVD, a magneto-optical medium, such as floptical disk, or the like.

In an embodiment, the obtaining unit 1310 may obtain syntax elements for decoding an image from the bitstream. Values corresponding to the syntax elements may be included in the bitstream according to a hierarchical structure of the image. The obtaining unit 1310 may obtain bins corresponding to the syntax elements by performing entropy decoding on the bitstream.

In an embodiment, the bitstream may include prediction information that is used to predict the current image. For example, the bitstream may include information indicating a prediction mode of the current block within the current image. The prediction mode of the current block may include an inter-mode. The inter-mode is a mode that predicts or reconstructs the current block, based on a reference image, so as to reduce temporal redundancy between images. In addition, when the prediction mode of the current block is the inter-mode, the prediction information may include information for determining a reference block. For example, the information for determining the reference block may include an index and motion information indicating the reference image within the reference picture list, but the present disclosure is not limited to the disclosed examples.

In an embodiment, the prediction decoding unit 1330 may generate the prediction block of the current block by performing inter-prediction on the current block according to the prediction mode of the current block, and may reconstruct the current block by using the prediction block.

In an embodiment, when the prediction decoding unit 1330 reconstructs the current block, based on the reference image, the prediction decoding unit 1330 may use one reference image (e.g., uni-prediction), or may use two reference images (e.g., bi-prediction). Whether the current block is uni-predicted or bi-predicted may be determined based on explicit information included in the bitstream, or may be determined implicitly from the prediction modes of neighboring blocks related to the current block.

In an embodiment, when the current block is bi-predicted, the prediction decoding unit 1330 may use the motion information included in the bitstream to determine reference blocks of the current block, or may perform implicit determination from reference blocks of neighboring blocks related to the current block. The motion information of the current block may include at least one of a reference image index, a motion vector, a differential motion vector, and a reference direction, and may include all pieces of information for predicting the motion vector of the current block.

In an embodiment, the prediction decoding unit 1330 may make the current image closer to the original image by performing in-loop filtering on the reconstructed image of the current image.

In an embodiment, the prediction decoding unit 1330 may obtain filter information from a sequence parameter set, an image parameter set, a slice header, or slice data of a bitstream. The filter information may include whether deblocking filtering, sample offset adaptive filtering, and adaptive loop filtering are performed, and filtering parameters that are used to perform each filtering.

In an embodiment, the prediction decoding unit 1330 may include an in-loop filtering unit. The in-loop filtering unit may include a filtering neural network including a feature extraction neural network and a regression neural network. In addition, the in-loop filtering unit may use a state encoding neural network and a layer information neural network to generate layer information for application to at least one layer within the filtering neural network.

In an embodiment, the prediction decoding unit 1330 may input information corresponding to the current image to the filtering neural network so as to generate an output image that is used to obtain an in-loop filtered image of the current image. The prediction decoding unit 1330 may obtain, from the filtering neural network, an output image that is used to obtain an image in which in-loop filtering of the current image has been applied.

In an embodiment, the prediction decoding unit may use state information corresponding to the reference block for each of the blocks for the current image so as to obtain the output image. For example, the state information for the reference image, which is obtained as the input of the layer information neural network so as to generate the layer information to be applied to the filtering neural network for the current image, may be determined by using the reference blocks corresponding to all blocks included in the current image. On the other hand, because the operation in which the prediction decoding unit generates the layer information by using the layer information neural network has been described in detail with reference to FIGS. 7 and 11A to 11C, the same redundant description thereof is omitted.

For example, when the current block is bi-predicted, the prediction decoding unit may perform a weighted sum by applying weights to the first reference block and the second reference block, respectively, and generate the prediction block for the current block. The state information corresponding to the reference block for each of the blocks included in the current image may use the state information obtained through the weighted sum performed by applying the weights, which are respectively applied to two reference blocks used for bi-prediction, to pieces of state information respectively corresponding to the two reference blocks.

On the other hand, for convenience of explanation, the method of using the state information for the reference block with respect to the block of the prediction unit has been described, but the present disclosure is not limited to the disclosed examples, and the prediction decoding unit may generate layer information by using state information corresponding to reference blocks used to predict each unit in a frame unit, a slice unit, a tile unit, a maximum CU, a CU, and a prediction unit. For example, to generate the layer information in frame units, the prediction decoding unit may generate layer information by inputting, to the layer information neural network, state information corresponding to reference blocks for blocks included in the current image.

In an embodiment, the prediction decoding unit may obtain layer information for application to the filtering neural network from the layer information neural network. The prediction decoding unit may obtain at least one of a convolution kernel and an attention map as the layer information for application to the filtering neural network. The prediction decoding unit may use the obtained layer information in the filtering neural network. For example, the prediction decoding unit may be configured to include a convolution layer in which the filtering neural network uses the convolution kernel and the attention map included in the layer information. The convolution kernel and the attention map of at least one convolution layer included in the filtering neural network may be determined based on the obtained layer information. On the other hand, because the operation in the prediction decoding device configures the filtering neural network by using the layer information has been described in detail with reference to FIGS. 7 and 8A to 8C, the same redundant description thereof is omitted.

In an embodiment, the prediction decoding unit may input, to the filtering neural network, information corresponding to the current image, including at least one of a reconstructed image of the current image, a prediction image of the current image, a first reference image of the current image, a second reference image of the current image, at least one quantization parameter for the current image, and division information for the current image.

In an embodiment, the prediction decoding unit may obtain a feature map corresponding to the current image, based on inputting, to the filtering neural network, the information corresponding to the current image. The prediction decoding unit may obtain an output image that is used to obtain an in-loop filtered image, based on inputting, to the filtering neural network, the information corresponding to the current image. For example, the prediction decoding unit may obtain a feature map corresponding to the current image by inputting, to the feature extraction neural network included in the filtering neural network, the information corresponding to the current image. The prediction decoding unit may obtain an output image that is used to obtain an in-loop filtered image from a regression neural network included in the filtering neural network that obtains the feature map corresponding to the current image as input. On the other hand, because the example structure of the filtering neural network has been described in detail with reference to FIGS. 7 and 9 to 10, the same redundant description thereof is omitted.

In an embodiment, the prediction decoding unit may obtain state information for the current image by using the feature map corresponding to the current image obtained from the filtering neural network. For example, the prediction decoding unit may obtain the feature map corresponding to the current image from the feature extraction neural network included in the filtering neural network. In addition, the prediction decoding unit may obtain state information for the current image, which has a resolution lower than a resolution of the reconstructed image or the prediction image of the current image, by inputting, to the state encoding neural network, the feature map corresponding to the current image. The state information for the current image may be obtained by inputting, to the state encoding neural network, the feature map corresponding to the current image and may be stored in the state information buffer.

On the other hand, because a detailed description of the state encoding neural network is also disclosed in FIG. 7, the same redundant description thereof is omitted.

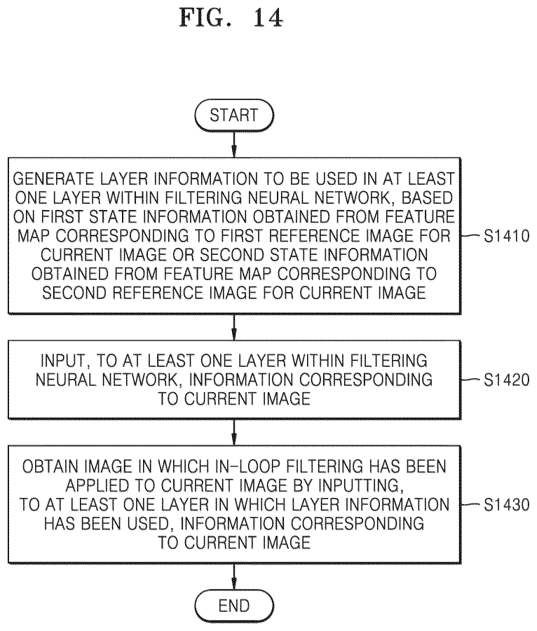

FIG. 14 is a flowchart of an image decoding method according to an embodiment of the present disclosure.

In operation S1410, the image decoding device 1300 may generate layer information to be used in at least one layer within the filtering neural network, based on first state information obtained from a feature map corresponding to a first reference image for a current image or second state information obtained from a feature map corresponding to a second reference image for the current image.

In an embodiment, the image decoding device 1300 may obtain prediction information from a bitstream. The prediction information may include information indicating that the first reference image and/or the second reference image are used to decode the current image. Specifically, the prediction information may include information indicating that the first reference image and/or the second reference image are used to decode a certain block included in the current image, and may include information indicating that a first reference block indicated by a first motion vector and/or a second reference block indicated by a second motion vector are used.

In an embodiment, the image decoding device 1300 may obtain the first state information, based on the feature map corresponding to the first reference image for the current image. The image decoding device 1300 may obtain the second state information, based on the feature map corresponding to the second reference image for the current image. The image decoding device 1300 may obtain the first state information corresponding to the first reference image by inputting, to the state encoding neural network, the feature map corresponding to the first reference image. The image decoding device 1300 may obtain the second state information corresponding to the second reference image by inputting, to the state encoding neural network, the feature map corresponding to the second reference image.

In an embodiment, the image decoding device 1300 may input, to the filtering neural network, the information corresponding to the first reference image. The image decoding device 1300 may obtain the feature map corresponding to the first reference image, based on inputting, to the filtering neural network, the information corresponding to the first reference image. For example, the image decoding device 1300 may obtain the feature map corresponding to the first reference image from the feature extraction neural network included in the filtering neural network. The image decoding device 1300 may obtain the first state information indicating the state information for the first reference image by inputting, to the state encoding neural network, the feature map corresponding to the first reference image. The first state information may have a resolution lower than a resolution of the first reference image.

In an embodiment, the image decoding device 1300 may input, to the filtering neural network, the information corresponding to the second reference image. The image decoding device 1300 may obtain the feature map corresponding to the second reference image, based on inputting, to the filtering neural network, the information corresponding to the second reference image. For example, the image decoding device 1300 may obtain the feature map corresponding to the second reference image from the feature extraction neural network included in the filtering neural network. The image decoding device 1300 may obtain the second state information indicating the state information for the second reference image by inputting, to the state encoding neural network, the feature map corresponding to the second reference image. The second state information may have a resolution lower than a resolution of the second reference image. On the other hand, the operation in which the image decoding device 1300 generates the state information for the current image has been described in detail with reference to FIGS. 1 to 13. Because the operation of generating the state information for the current image may correspond to the operation of generating the first state information for the first reference image and/or the second state information for the second reference image, the same redundant description thereof is omitted.

In an embodiment, the image decoding device 1300 may store the first state information and/or the second state information in the state information buffer. The image decoding device 1300 may use the first state information and/or the second state information to obtain an image in which in-loop filtering has been applied to the current image.

In an embodiment, when a certain block included in the current image uses, as reference blocks, blocks included in the first reference image and/or the second reference image, the image decoding device 1300 may generate or obtain a prediction image by using the reference blocks. The image decoding device 1300 may input, to the layer information neural network, pieces of state information corresponding to the reference blocks used to generate the prediction image for the current image.

In an embodiment, the image decoding device 1300 may generate layer information to be applied to at least one layer within the filtering neural network, based on inputting the first state information and the second state information to the layer information neural network. The layer information may include at least one of a kernel and an attention map for application to the at least one layer within the filtering neural network.

On the other hand, because the layer information has been described in detail with reference to FIGS. 1 to 13, detailed descriptions redundant with those provided above are omitted.

In operation S1420, the image decoding device 1300 may input, to the at least one layer within the filtering neural network, information corresponding to the current image.

In an embodiment, the image decoding device 1300 may apply the generated layer information to the filtering neural network. For example, the feature extraction neural network included in the filtering neural network may include a neural layer that uses a convolution kernel included in the layer information. Alternatively, the regression neural network included in the filtering neural network may include a neural layer including an attention map included in the layer information. However, the present disclosure is not limited to the disclosed examples. In addition, the layer information applied to the feature extraction neural network and the layer information applied to the regression neural network may be different because the purposes of the respective neural networks are different from each other.

In an embodiment, the image decoding device 1300 may input information corresponding to the current image to the at least one layer within the filtering neural network in which the layer information has been used. The image decoding device 1300 may input information corresponding to the current image to the filtering neural network including the at least one layer in which the layer information has been used. The information corresponding to the current image may include at least one of a reconstructed image for the current image, a deblock-filtered image for the current image, a sample adaptive offset filtered image for the current image, an adaptive loop filtered image for the current image, a prediction image for the current image, a first reference image for the current image, a second reference image for the current image, at least one quantization parameter for the current image, and division information for the current image.

In an embodiment, the image decoding device 1300 may input, to the feature extraction neural network included in the filtering neural network, the information corresponding to the current image. On the other hand, because the operation in which the image decoding device 1300 inputs the generated layer information to the filtering neural network and the at least one layer within the filtering neural network has been described in detail with reference to FIGS. 1 to 13, the same description thereof is omitted.

In operation S1430, the image decoding device 1300 may obtain an image in which in-loop filtering has been applied to the current image by inputting, to at least one layer in which the layer information has been used, the information corresponding to the current image.

In an embodiment, the image decoding device 1300 may obtain, from the filtering neural network, an output image that is used to obtain an in-loop filtered image in which in-loop filtering has been performed on the current image.

In an embodiment, the feature extraction neural network included in the filtering neural network may generate a feature map corresponding to the current image in response to inputting, by the image decoding device 1300, the information corresponding to the current image to the filtering neural network. In addition, the feature map corresponding to the current image, which is obtained from the feature extraction neural network, may be input to the regression neural network included in the filtering neural network. The image decoding device 1300 may obtain the output image from the regression neural network that receives the feature map corresponding to the current image.

In an embodiment, when the filtering neural network and the deblocking filtering unit are configured in parallel within the in-loop filtering unit, the image decoding device 1300 may obtain an in-loop filtered image, based on performing an addition operation on the output image, which is the output of the filtering neural network, and the deblock-filtered image. For example, the image decoding device 1300 may obtain an image in which in-loop filtering has been applied, by performing sample adaptive loop filtering and adaptive loop filtering on the result of performing the addition operation on the output image and the deblock-filtered image.

In an embodiment, when the filtering neural network is positioned in series after the deblocking filtering unit within the in-loop filtering unit, the image decoding device 1300 may input the deblock-filtered image to the filtering neural network as one of pieces of information corresponding to the current image. The image decoding device 1300 may obtain an image in which in-loop filtering has been applied, by performing sample adaptive offset filtering and adaptive loop filtering on the output image obtained from the filtering neural network.

On the other hand, the present disclosure is not limited to the disclosed examples. The location of the filtering neural network may be adjusted according to the design of the in-loop filtering unit, and the filtering neural network may be trained to generate an appropriate output image according to the location of the filtering neural network.

On the other hand, because the operation of generating the output image from the filtering neural network has been described in detail with reference to FIGS. 1 to 13, the same redundant description thereof is omitted.

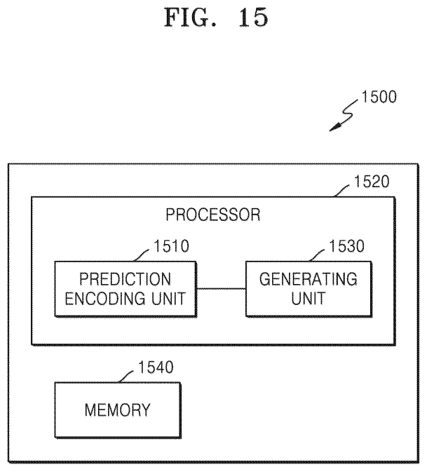

FIG. 15 is a block diagram illustrating a configuration of an image encoding device according to an embodiment of the present disclosure.

Referring to FIG. 15, an image encoding device 1500 may include at least one processor 1520 and memory 1540 storing instructions, and the at least one processor 1520 may include or implement a prediction encoding unit 1510 and a generating unit 1530. The prediction encoding unit 1510 illustrated in FIG. 15 may correspond to the prediction encoding unit 115 illustrated in FIG. 1, and the generating unit 1530 may correspond to the in-loop filtering unit and the prediction encoding unit illustrated in FIG. 1.

The prediction encoding unit 1510 and the generating unit 1530, according to an embodiment, may be implemented by the at least one processor 1520. In an embodiment, the prediction encoding unit 1510 and the generating unit 1530 may operate according to at least one instruction stored in the memory 1540.

On the other hand, because the at least one processor 1520 and the memory 1540 of the image encoding device 1500 respectively correspond to the at least one processor 1320 and the memory 1340 of the image decoding device 1300, the same description thereof is omitted. In the subsequent embodiments, operations described as being performed by the detailed components (1510 and 1530 of FIG. 15) included in the image encoding device 1500 or the image decoding device 1300 may be considered as being performed by the processor unless otherwise stated.

In an embodiment, the image encoding device 1500 may perform operations that are performed in the image decoding device 1300 or the units included in the image decoding device 1300. The same redundant description thereof is omitted.

In an embodiment, the image encoding device 1500 may include at least one memory that stores input and output data of the prediction encoding unit 1510 and the generating unit 1530. In addition, the image encoding device 1500 may include a memory control unit that controls data input and output of the memory.

In an embodiment, the prediction encoding unit 1510 may determine prediction information for generating a prediction block for a current block within a current image. For example, the prediction information may include information indicating that the prediction mode of the current block is an inter-mode. The inter-mode is a mode that predicts or reconstructs the current block, based on a reference image, so as to reduce temporal redundancy between images. The current block may be a maximum CU, a CU, a transform unit, or a prediction unit divided from a current image to be encoded. In addition, when the prediction mode of the current block is the inter-mode, the prediction information may include information for determining a reference block. For example, the information for determining the reference block may include an index and motion information indicating the reference image within the reference picture list, but the present disclosure is not limited to the disclosed examples.

In an embodiment, the prediction encoding unit 1510 may perform inter-prediction on the current block, based on the determined prediction information for the current block, and may encode the current block by using the prediction block generated as the result of performing the inter-prediction.

In an embodiment, when the prediction encoding unit 1510 encodes the current block, based on the reference image, the prediction encoding unit 1510 may use one reference image (e.g., uni-prediction), or may use two reference images (e.g., bi-prediction). Whether the current block is uni-predicted or bi-predicted may also be included in the bitstream as the determined prediction information for the current block, and may be information expressed as a flag or an index. When whether uni-prediction or bi-prediction is performed on the current block is implicitly determined from the prediction modes of neighboring blocks related to the current block, information about the neighboring blocks may be included in the bitstream as a flag or an index.

In an embodiment, when the current block is bi-predicted, the prediction encoding unit 1510 may identify motion information that is used to determine reference blocks of the current block, and the motion information may be included in the prediction information. The motion information of the current block may be included in the bitstream. The motion information of the current block may include at least one of a reference image index, a motion vector, a differential motion vector, and a reference direction, and may include all pieces of information for predicting the motion vector of the current block.

In an embodiment, the prediction information may be included in a sequence parameter set, a picture parameter set, a slice header, or slice data of the bitstream.

In an embodiment, the encoding of the current block may refer to a process of generating information that enables the image decoding device 1300 to reconstruct the current block. The information generated through encoding may be included in the bitstream.

In an embodiment, when the prediction block is generated by performing the bi-prediction on the current block, the prediction encoding unit 1510 may encode the current block by using the prediction block. The prediction encoding unit 1510 may generate residual data corresponding to the difference between the prediction block and the current block. When the predicted block is determined to be the current block, residual data may not be generated.

In an embodiment, the generating unit 1530 may generate the bitstream including the result of encoding the image. The bitstream may include the result of encoding the current block. The generating unit 1530 may transmit the bitstream to the image decoding device 1300 through a network.

In an embodiment, the generating unit 1530 may store the bitstream in a data storage medium including a magnetic medium, such as hard disk, floppy disk, and magnetic tape, an optical recording medium, such as CD-ROM and DVD, a magneto-optical medium, such as floptical disk, or the like. The generating unit 1530 may generate the bitstream including syntax elements generated through the encoding of the image. Values corresponding to the syntax elements may be included in the bitstream according to a hierarchical structure of the image. Bitstreams generated when the generating unit 1530 performs entropy encoding on the syntax elements may be included in the bitstream.

In an embodiment, the prediction encoding unit 1510 may perform the same filtering as the in-loop filtering performed in the prediction decoding unit. On the other hand, although not explicitly disclosed, the operation performed in the prediction decoding unit or the image decoding device 1300 disclosed through FIGS. 1 to 14 may also be performed in the prediction encoding unit 1510.

In an embodiment, the prediction encoding unit 1510 may determine filter information for filtering performed in the in-loop filtering unit. For example, the filter information may include information that is used to perform deblocking filtering, sample offset adaptive filtering, and adaptive loop filtering included in the in-loop filtering unit. The filter information may include whether deblocking filtering, sample offset adaptive filtering, and adaptive loop filtering are performed, and filtering parameters for performing each filtering.

In an embodiment, the prediction encoding unit 1510 may perform in-loop filtering on the current block or the current image, based on the determined filter information for the current block or the current image, and may encode the current block by using the in-loop filtered block or the in-loop filtered image generated as the result of performing the in-loop filtering. For example, the prediction encoding unit 1510 may store the in-loop filtered image in a picture buffer and may encode the image by using the in-loop filtered image as a reference image. On the other hand, the in-loop filtered image may be an image in which in-loop filtering has been applied.

In an embodiment, the filter information may be included in a sequence parameter set, a picture parameter set, a slice header, or slice data of the bitstream.

In an embodiment, the prediction encoding unit 1510 may input information corresponding to the current image to the filtering neural network so as to generate an output image that is used to obtain the in-loop filtered image of the current image. The prediction encoding unit 1510 may obtain an output image for the current image from the filtering neural network.

In an embodiment, the prediction encoding unit 1510 may include an in-loop filtering unit. The in-loop filtering unit may include a filtering neural network including a feature extraction neural network and a regression neural network. In addition, the in-loop filtering unit may use a state encoding neural network and a layer information neural network to generate layer information to be used in at least one layer within the filtering neural network.

In an embodiment, the prediction encoding unit 1510 may use state information corresponding to the reference block for each of the blocks for the current image so as to obtain the output image. For example, the state information for the reference image, which is obtained as the input of the layer information neural network so as to generate the layer information to be applied to the filtering neural network for the current image, may be determined by using the reference blocks corresponding to all blocks included in the current image. On the other hand, because the operation in which the prediction encoding unit 1510 generates the layer information by using the layer information neural network has been described in detail with reference to FIGS. 7 and 11A to 11C, the same redundant description thereof is omitted.

For example, when the current block is bi-predicted, the prediction encoding unit 1510 may perform a weighted sum by applying weights to the first reference block and the second reference block, respectively, and generate the prediction block for the current block. The state information corresponding to the reference block for each of the blocks included in the current image may use the state information obtained through the weighted sum performed by applying the weights, which are respectively applied to two reference blocks used for bi-prediction, to pieces of state information respectively corresponding to the two reference blocks.

On the other hand, for convenience of explanation, the method of using the state information for the reference block with respect to the block of the prediction unit has been described, but the present disclosure is not limited to the disclosed examples, and the prediction encoding unit 1510 may generate layer information by using state information corresponding to reference blocks used to predict each unit in a frame unit, a slice unit, a tile unit, a maximum CU, a CU, and a prediction unit. For example, to generate the layer information in frame units, the prediction encoding unit 1510 may generate layer information by inputting, to the layer information neural network, state information corresponding to reference blocks for blocks included in the current image.

In an embodiment, the prediction encoding unit 1510 may obtain, from the layer information neural network, layer information to be used in at least one layer within the filtering neural network. The prediction encoding unit 1510 may obtain at least one of a convolution kernel and an attention map as the layer information for application to the filtering neural network. The prediction encoding unit 1510 may use the obtained layer information in the filtering neural network. For example, the prediction encoding unit 1510 may use the attention map to configure a filtering neural network to include a convolution layer that uses the convolution kernel and the attention map included in the layer information. The convolution kernel and the attention map of at least one convolution layer included in the filtering neural network may be determined based on the obtained layer information. On the other hand, because the operation in the prediction decoding device configures the filtering neural network by using the layer information has been described in detail with reference to FIGS. 7 and 8A to 8C, the same redundant description thereof is omitted.

In an embodiment, the prediction encoding unit 1510 may input, to the filtering neural network, information corresponding to the current image, including at least one of a reconstructed image of the current image, a prediction image of the current image, a first reference image of the current image, a second reference image of the current image, at least one quantization parameter for the current image, and division information for the current image.

In an embodiment, the prediction encoding unit 1510 may obtain a feature map corresponding to the current image, based on inputting, to the filtering neural network, the information corresponding to the current image. The prediction encoding unit 1510 may obtain an output image that is used to obtain an image in which in-loop filtering has been applied, based on inputting, to the filtering neural network, the information corresponding to the current image. For example, the prediction encoding unit 1510 may obtain a feature map corresponding to the current image by inputting, to the feature extraction neural network included in the filtering neural network, the information corresponding to the current image. The prediction encoding unit 1510 may obtain an output image from the regression neural network included in the filtering neural network, based on inputting the feature map corresponding to the current image. On the other hand, because the example structure of the filtering neural network has been described in detail with reference to FIGS. 7 and 9 to 10, the same redundant description thereof is omitted.

In an embodiment, the prediction encoding unit 1510 may obtain state information for the current image by using the feature map corresponding to the current image obtained from the filtering neural network. For example, the prediction encoding unit 1510 may obtain the feature map corresponding to the current image from the feature extraction neural network included in the filtering neural network. In addition, the prediction encoding unit 1510 may obtain state information for the current image, which has a resolution lower than a resolution of the reconstructed image or the prediction image of the current image, by inputting, to the state encoding neural network, the feature map corresponding to the current image. The state information for the current image may be obtained by inputting, to the state encoding neural network, the feature map corresponding to the current image and may be stored in the state information buffer.

On the other hand, because a detailed description of the state encoding neural network is also disclosed in FIG. 7, the same redundant description thereof is omitted.

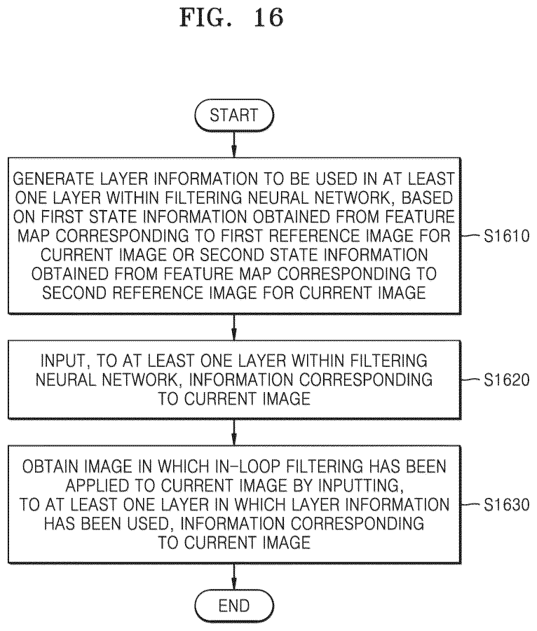

FIG. 16 is a flowchart of an image encoding method according to an embodiment of the present disclosure.

In operation S1610, the image encoding device 1500 may generate layer information to be used in at least one layer within the filtering neural network, based on first state information obtained from a feature map corresponding to a first reference image for a current image or second state information obtained from a feature map corresponding to a second reference image for the current image.

In an embodiment, the image encoding device 1500 may generate the layer information by using the determined prediction information. The prediction information may include information indicating that the first reference image and/or the second reference image are used to decode the current image. Specifically, the prediction information may include information indicating that the first reference image and/or the second reference image are used to decode a certain block included in the current image, and may include information indicating that a first reference block indicated by a first motion vector and/or a second reference block indicated by a second motion vector are used. The image encoding device 1500 may determine prediction information and generate a bitstream including the determined prediction information.

In an embodiment, the image encoding device 1500 may obtain the first state information, based on the feature map corresponding to the first reference image for the current image. The image encoding device 1500 may obtain the second state information, based on the feature map corresponding to the second reference image for the current image. The image encoding device 1500 may obtain the first state information corresponding to the first reference image by inputting, to the state encoding neural network, the feature map corresponding to the first reference image. The image encoding device 1500 may obtain the second state information corresponding to the second reference image by inputting, to the state encoding neural network, the feature map corresponding to the second reference image.

In an embodiment, the image encoding device 1500 may input, to the filtering neural network, the information corresponding to the first reference image. The image encoding device 1500 may obtain the feature map corresponding to the first reference image, based on inputting, to the filtering neural network, the information corresponding to the first reference image. For example, the image encoding device 1500 may obtain the feature map corresponding to the first reference image from the feature extraction neural network included in the filtering neural network. The image encoding device 1500 may obtain the first state information indicating the state information for the first reference image by inputting, to the state encoding neural network, the feature map corresponding to the first reference image. The first state information may have a resolution lower than a resolution of the first reference image.

In an embodiment, the image encoding device 1500 may input, to the filtering neural network, the information corresponding to the second reference image. The image encoding device 1500 may obtain the feature map corresponding to the second reference image, based on inputting, to the filtering neural network, the information corresponding to the second reference image. For example, the image encoding device 1500 may obtain the feature map corresponding to the second reference image from the feature extraction neural network included in the filtering neural network. The image encoding device 1500 may obtain the second state information indicating the state information for the second reference image by inputting, to the state encoding neural network, the feature map corresponding to the second reference image. The second state information may have a resolution lower than a resolution of the second reference image. On the other hand, the operation in which the image encoding device 1500 generates the state information for the current image has been described in detail with reference to FIGS. 1 to 13. Because the operation of generating the state information for the current image may correspond to the operation of generating the first state information for the first reference image and/or the second state information for the second reference image, the same redundant description thereof is omitted.

In an embodiment, the image encoding device 1500 may store the first state information and/or the second state information in the state information buffer. The image encoding device 1500 may use the first state information and/or the second state information to obtain an image in which in-loop filtering has been applied to the current image.

In an embodiment, when a certain block included in the current image uses, as reference blocks, blocks included in the first reference image and/or the second reference image, the image encoding device 1500 may generate or obtain a prediction image by using the reference blocks. The image encoding device 1500 may input, to the layer information neural network, pieces of state information corresponding to the reference blocks used to generate the prediction image for the current image.

In an embodiment, the image encoding device 1500 may generate layer information to be applied to at least one layer within the filtering neural network, based on inputting the first state information and the second state information to the layer information neural network. The layer information may include at least one of a kernel and an attention map for application to the at least one layer within the filtering neural network.

On the other hand, because the layer information has been described in detail with reference to FIGS. 1 to 13, detailed descriptions redundant with those provided above are omitted.

In operation S1620, the image encoding device 1500 may input, to the at least one layer within the filtering neural network, information corresponding to the current image.

In an embodiment, the image encoding device 1500 may apply the generated layer information to the filtering neural network. For example, the feature extraction neural network included in the filtering neural network may include a neural layer that uses a convolution kernel included in the layer information. Alternatively, the regression neural network included in the filtering neural network may include a neural layer including an attention map included in the layer information. However, the present disclosure is not limited to the disclosed examples. In addition, the layer information applied to the feature extraction neural network and the layer information applied to the regression neural network may be different because the purposes of the respective neural networks are different from each other.

In an embodiment, the image encoding device 1500 may input information corresponding to the current image to the at least one layer within the filtering neural network in which the layer information has been used. The image encoding device 1500 may input information corresponding to the current image to the filtering neural network including the at least one layer in which the layer information has been used. The information corresponding to the current image may include at least one of a reconstructed image for the current image, a deblock-filtered image for the current image, a sample adaptive offset filtered image for the current image, an adaptive loop filtered image for the current image, a prediction image for the current image, a first reference image for the current image, a second reference image for the current image, at least one quantization parameter for the current image, and division information for the current image.

In an embodiment, the image encoding device 1500 may input, to the feature extraction neural network included in the filtering neural network, the information corresponding to the current image. On the other hand, because the operation in which the image encoding device 1500 inputs the generated layer information to the filtering neural network and the at least one layer within the filtering neural network has been described in detail with reference to FIGS. 1 to 13, the same description thereof is omitted.

In operation S1630, the image encoding device 1500 may obtain an image in which in-loop filtering has been applied to the current image by inputting, to at least one layer in which the layer information has been used, the information corresponding to the current image.

In an embodiment, the image encoding device 1500 may obtain, from the filtering neural network, an output image that is used to obtain an in-loop filtered image in which in-loop filtering has been performed on the current image.

In an embodiment, the feature extraction neural network included in the filtering neural network may generate a feature map corresponding to the current image in response to inputting, by the image encoding device 1500, the information corresponding to the current image to the filtering neural network. In addition, the feature map corresponding to the current image, which is obtained from the feature extraction neural network, may be input to the regression neural network included in the filtering neural network. The image encoding device 1500 may obtain the output image from the regression neural network that receives the feature map corresponding to the current image.

In an embodiment, when the filtering neural network and the deblocking filtering unit are configured in parallel within the in-loop filtering unit, the image encoding device 1500 may obtain an in-loop filtered image, based on performing an addition operation on the output image, which is the output of the filtering neural network, and the deblock-filtered image. For example, the image encoding device 1500 may obtain an image in which in-loop filtering has been applied, by performing sample adaptive loop filtering and adaptive loop filtering on the result of performing the addition operation on the output image and the deblock-filtered image.

In an embodiment, when the filtering neural network is positioned in series after the deblocking filtering unit within the in-loop filtering unit, the image encoding device 1500 may input the deblock-filtered image to the filtering neural network as one of pieces of information corresponding to the current image. The image encoding device 1500 may obtain an image in which in-loop filtering has been applied, by performing sample adaptive offset filtering and adaptive loop filtering on the output image obtained from the filtering neural network.

On the other hand, the present disclosure is not limited to the disclosed examples. The location of the filtering neural network may be adjusted according to the design of the in-loop filtering unit, and the filtering neural network may be trained to generate an appropriate output image according to the location of the filtering neural network.

On the other hand, because the operation of generating the output image from the filtering neural network has been described in detail with reference to FIGS. 1 to 13, the same redundant description thereof is omitted.

On the other hand, because the operation of generating the output image from the filtering neural network has been described in detail with reference to FIGS. 1 to 15, the same redundant description thereof is omitted. In addition, the operations of FIG. 16 may correspond to the disclosures of FIGS. 1 to 14, except that the operations of FIG. 16 are performed in the image encoding device 1500.

In an embodiment, the image decoding method may include operation S1410 of generating layer information to be used in at least one layer within the filtering neural network 720, based on first state information obtained from a feature map corresponding to a first reference image for a current image or second state information obtained from a feature map corresponding to a second reference image for the current image. The image decoding method may include operation S1420 of inputting, to at least one layer within the filtering neural network 720, information 710 corresponding to the current image. The image decoding method may include operation S1430 of obtaining an image in which in-loop filtering has been applied to the current image by inputting, to at least one layer in which layer information has been used, the information 710 corresponding to the current image. State information 735 for the current image may be obtained from a feature map 725 corresponding to the current image and may have a resolution lower than a resolution of the current image.

In an embodiment, the layer information may include at least one of a kernel and an attention map for application to at least one layer within the filtering neural network 720.

In an embodiment, the first reference image may be an image included in a first reference picture list of the current image. The second reference image may be an image included in a second reference picture list of the current image. A POC value of the first reference image may be less than a POC value of the current image. A POC value of the second reference image may be greater than a POC value of the current image.

In an embodiment, the first reference image and the second reference image are images included in the second reference picture list of the current image, and each of the POC value of the first reference image and the POC value of the second reference image may be greater than the POC value of the current image.

In an embodiment, the state information 735 for the current image may be obtained by inputting, to the state encoding neural network 730, the feature map 725 corresponding to the current image. The state information 735 for the current image may be stored in the state information buffer 740.

In an embodiment, the first state information may be obtained by inputting, to the state encoding neural network 730, the feature map corresponding to the first reference image. The first state information may be stored in the state information buffer 740.

In an embodiment, the second state information may be obtained by inputting, to the state encoding neural network 730, the feature map corresponding to the second reference image. The second state information may be stored in the state information buffer 740.

In an embodiment, the filtering neural network 720 may include a feature extraction neural network 721 that extracts features of the current image from information corresponding to the current image and generates a feature map corresponding to the current image, and a regression neural network 726 that is used to obtain, from the feature map corresponding to the current image, an image in which in-loop filtering has been applied to the current image.

In an embodiment, the information 710 corresponding to the current image may include at least one of a reconstructed image of the current image, a prediction image of the current image, a first reference image, a second reference image, at least one quantization parameter for the current image, and division information for the current image.

In an embodiment, the image decoding method may obtain an in-loop filtered image for the current image, based on performing an addition operation on an output image 760 obtained from the regression neural network 726 and a deblock-filtered image of the current image.

In an embodiment, the filtering neural network may include at least one of a deep neural network, a convolution neural network, and a transformer neural network.

In an embodiment, the feature extraction neural network 721 may include at least one down-sampling layer for generating the feature map 725 corresponding to the current image, which has a resolution lower than a resolution of the current image.

In an embodiment, the regression neural network 726 may include at least one up-sampling layer for generating an output image that has a resolution higher than a resolution of the feature map 725 corresponding to the current image.

In an embodiment, the state encoding neural network 730 may include at least one down-sampling layer, and the at least one down-sampling layer may include at least one of a stride convolution layer and a pooling layer.

In an embodiment, the layer information neural network used to generate layer information may include at least one of a stride convolution layer, a pooling layer, an interpolation layer, a deconvolution layer, and a pixel shuffle layer.

In an embodiment, the filtering neural network, the state encoding neural network, and the layer information neural network may be trained together, based on inputting, to the filtering neural network, information corresponding to the first reference image or information corresponding to the second reference image and inputting, to the filtering neural network, information corresponding to the current image.

In an embodiment, the image decoding device 1300 may include at least one memory that stores at least one instruction and at least one processor that operates according to the at least one instruction. The at least one processor may generate layer information that is used in at least one layer within the filtering neural network 720, based on first state information obtained from a feature map corresponding to the first reference image for the current image or second state information obtained from a feature map corresponding to the second reference image for the current image. The at least one processor may input, to at least one layer within the filtering neural network 720, the information 710 corresponding to the current image. The at least one processor may obtain an image in which in-loop filtering has been applied to the current image by inputting, to at least one layer in which layer information has been used, the information 710 corresponding to the current image. The state information 735 for the current image may be obtained from the feature map 725 corresponding to the current image and may have a resolution lower than a resolution of the current image.

In an embodiment, the image encoding method may include operation S1610 of generating layer information to be used in at least one layer within the filtering neural network 720, based on the first state information obtained from the feature map corresponding to the first reference image for the current image or the second state information obtained from the feature map corresponding to the second reference image for the current image. In an embodiment, the image encoding method may include operation S1620 of inputting, to at least one layer within the filtering neural network 720, the information 710 corresponding to the current image.

In an embodiment, the image encoding method may include operation S1630 of obtaining an image in which in-loop filtering has been applied to the current image by inputting, to at least one layer in which layer information has been used, the information 710 corresponding to the current image. The state information 735 for the current image may be obtained from the feature map 725 corresponding to the current image and may have a resolution lower than a resolution of the current image.

In an embodiment, the image encoding device 1500 may include at least one memory that stores at least one instruction and at least one processor that operates according to the at least one instruction. The at least one processor may generate layer information that is used in at least one layer within the filtering neural network 720, based on first state information obtained from a feature map corresponding to the first reference image for the current image or second state information obtained from a feature map corresponding to the second reference image for the current image. The at least one processor may input, to at least one layer within the filtering neural network 720, the information 710 corresponding to the current image. The at least one processor may obtain an image in which in-loop filtering has been applied to the current image by inputting, to at least one layer in which layer information has been used, the information 710 corresponding to the current image. State information 735 for the current image may be obtained from a feature map 725 corresponding to the current image and may have a resolution lower than a resolution of the current image.

In an embodiment, a computer-readable recording medium having a bitstream recorded thereon may be provided. The bitstream may include prediction information that is used to predict the current image. Based on the prediction information, layer information to be used in at least one layer within the filtering neural network 720 may be generated based on the first state information obtained from the feature map corresponding to the first reference image or the second state information obtained from the feature map corresponding to the second reference image. The information 710 corresponding to the current image may be input to at least one layer in the filtering neural network 720. An image in which in-loop filtering has been applied to the current image may be obtained by inputting, to at least one layer in which layer the information has been used, the information 710 corresponding to the current image. The state information 735 for the current image may be obtained from the feature map 725 corresponding to the current image and may have a resolution lower than a resolution of the current image.

Various embodiments of the present disclosure may be implemented or supported by one or more computer programs, and the computer programs may be formed from computer-readable program code and recorded on a computer-readable medium. In the present disclosure, the “application” and the “program” may refer to one or more computer programs, software components, instruction sets, procedures, functions, objects, classes, instances, associated data, or parts thereof, which are suitable for implementation in computer-readable program code. The “computer-readable program code” may include various types of computer code, including source code, object code, and executable code. The “computer-readable medium” may include various types of media that are accessible by a computer, such as ROM, RAM, hard disk drive (HDD), compact disc (CD), DVD, or other types of memory.

In addition, a storage medium that is readable by a machine may be provided in the form of a non-transitory storage medium. The ‘non-transitory storage medium’ is a tangible device and may exclude wired, wireless, optical, or other communication links that transmit temporary electrical or other signals. On the other hand, the ‘non-transitory storage medium’ does not distinguish between a case where data is semi-permanently stored on the storage medium and a case where data is temporarily stored. For example, the ‘non-transitory storage medium’ may include a buffer in which data is temporarily stored. The computer-readable recording medium may be any available media that are accessible by a computer and may include any volatile and non-volatile media and any removable and non-removable media. The computer-readable medium includes a medium on which data may be permanently stored and a medium on which data may be stored and overwritten later, for example, a rewritable optical disk or an erasable memory device.

A method according to an embodiment of the present disclosure may be provided by being included in a computer program product. A computer program product may be traded between a seller and a buyer as commodities. The computer program product may be distributed in the form of a machine-readable storage medium (e.g., CD-ROM), or may be distributed (e.g., downloaded or uploaded) online either via an application store or directly between two user devices (e.g., smartphones). In the case of the online distribution, at least a part of a computer program product (e.g., a downloadable app) is stored at least temporarily on a machine-readable storage medium, such as a server of a manufacturer, a server of an application store, or memory of a relay server, or may be temporarily generated.

The foregoing description of the present disclosure is for illustrative purposes only, and those of ordinary skill in the art to which the present disclosure pertains will understand that modifications into other specific forms may be made thereto without changing the technical spirit or essential features of the present disclosure. For example, appropriate results may be achieved even when the technologies described above are performed in an order different from the methods described above, and/or components of the computer system or modules described above are coupled or combined in a manner different from the methods described above or are replaced or substituted by other components or equivalents. Therefore, it should be understood that the embodiments described above are illustrative in all respects and are not restrictive. For example, components described as a single entity may be implemented in a distributed manner. Similarly, components described as distributed may be implemented in a combined manner.

The scope of the present disclosure is indicated by the claims described below, and all changes or modifications derived from the meaning and scope of the claims and the equivalent concepts thereof should be interpreted as falling within the scope of the present disclosure.

What is claimed is:

1. An image decoding method comprising:
generating, based on first state information obtained from a feature map corresponding to a first reference image for a current image or second state information obtained from a feature map corresponding to a second reference image for the current image, layer information to be used in at least one layer within a filtering neural network;
inputting, to the at least one layer within the filtering neural network, information corresponding to the current image; and
obtaining an image in which in-loop filtering has been applied to the current image by inputting, to the at least one layer in which the layer information has been used, the information corresponding to the current image,
wherein state information for the current image is obtained from a feature map corresponding to the current image and the state information for the current image has a resolution lower than a resolution of the current image.

2. The image decoding method of claim 1, wherein the layer information includes at least one of a kernel or an attention map for application to the at least one layer within the filtering neural network.

3. The image decoding method of claim 1, wherein the first reference image is an image included in a first reference picture list of the current image,
wherein the second reference image is an image included in a second reference picture list of the current image,
wherein a picture order count (POC) value of the first reference image is less than a POC value of the current image, and
wherein a POC value of the second reference image is greater than the POC value of the current image.

4. The image decoding method of claim 3, wherein the first reference image and the second reference image are included in a second reference picture list of the current image, and
wherein each of the POC value of the first reference image and the POC value of the second reference image is greater than the POC value of the current image.

5. The image decoding method of claim 1, wherein the state information for the current image is obtained by inputting, to a state encoding neural network, the feature map corresponding to the current image and is stored in a state information buffer.

6. The image decoding method of claim 1, wherein the first state information is obtained by inputting, to a state encoding neural network, a feature map corresponding to the first reference image, and the first state information is stored in a state information buffer, and
wherein the second state information is obtained by inputting, to the state encoding neural network, a feature map corresponding to the second reference image, and the second state information is stored in the state information buffer.

7. The image decoding method of claim 1, wherein the filtering neural network comprises:
a feature extraction neural network configured to extract features of the current image from information corresponding to the current image and generate a feature map corresponding to the current image; and
a regression neural network configured to obtain, from the feature map corresponding to the current image, the image in which the in-loop filtering has been applied to the current image.

8. The image decoding method of claim 1, wherein the information corresponding to the current image comprises at least one of a reconstructed image of the current image, a prediction image of the current image, the first reference image, the second reference image, at least one quantization parameter for the current image, or division information for the current image.

9. The image decoding method of claim 7, wherein the obtaining the image in which the in-loop filtering has been applied to the current image comprises obtaining the in-loop filtered image for the current image, based on performing an addition operation on an output image obtained from the regression neural network and a deblock-filtered image of the current image.

10. The image decoding method of claim 1, wherein the filtering neural network comprises at least one of a deep neural network, a convolution neural network, or a transformer neural network.

11. The image decoding method of claim 7, wherein the feature extraction neural network comprises at least one down-sampling layer for generating the feature map corresponding to the current image, and the feature map has a resolution lower than a resolution of the current image.

12. The image decoding method of claim 7, wherein the regression neural network comprises at least one up-sampling layer for generating an output image that has a resolution higher than a resolution of the feature map corresponding to the current image.

13. The image decoding method of claim 5, wherein the filtering neural network, the state encoding neural network, and a layer information neural network that is used to generate the layer information are trained together, based on inputting, to the filtering neural network, information corresponding to the first reference image or information corresponding to the second reference image and inputting, to the filtering neural network, information corresponding to the current image.

14. An image encoding method comprising:
generating, based on first state information obtained from a feature map corresponding to a first reference image for a current image or second state information obtained from a feature map corresponding to a second reference image for the current image, layer information to be used in at least one layer within a filtering neural network;
inputting, to the at least one layer within the filtering neural network, information corresponding to the current image; and
obtaining an image in which in-loop filtering has been applied to the current image by inputting, to the at least one layer in which the layer information has been used, the information corresponding to the current image,
wherein state information for the current image is obtained from a feature map corresponding to the current image and the state information for the current image has a resolution lower than a resolution of the current image.

15. A method for transmitting a bitstream generated by image encoding, comprising:
generating, based on first state information obtained from a feature map corresponding to a first reference image for a current image or second state information obtained from a feature map corresponding to a second reference image for the current image, layer information to be used in at least one layer within a filtering neural network;
inputting, to the at least one layer within the filtering neural network, information corresponding to the current image; and
obtaining an image in which in-loop filtering has been applied to the current image by inputting, to the at least one layer in which the layer information has been used, the information corresponding to the current image,
wherein state information for the current image is obtained from a feature map corresponding to the current image and the state information for the current image has a resolution lower than a resolution of the current image.
